(19) United States
(12) Patent Application Publication
(10) Pub. No.: US 2010/0026903 A1
(43) Pub. Date: Feb. 4, 2010

(54) MOTION VECTOR DETECTION DEVICE, MOTION VECTOR DETECTION METHOD, AND PROGRAM

(75) Inventors: Hiroki TETSUKAWA, Kanagawa (JP); Tetsujiro Kondo, Tokyo (JP); Kenji Takahashi, Kanagawa (JP); Kazushi Yoshikawa, Tokyo (JP); Naoki Takeda, Tokyo (JP); Takanori Ishikawa, Saitama (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/510,964

(22) Filed: Jul. 28, 2009

(30) Foreign Application Priority Data
Jul. 30, 2008 (JP) 2008-196612

(51) Int. Cl. H04N 5/14

(52) U.S. Cl. 348/699; 348/E05.062

(57) ABSTRACT

A motion vector detection device includes: an evaluation value information creation unit creating, from correlation information of a target pixel in one frame and a reference pixel in another frame in moving image data including frames, evaluation value information evaluating the possibility that the reference pixel is a candidate for the destination of motion from the target pixel; a motion vector extraction unit extracting motion vector candidates of each of the pixels in a frame by using the evaluation value information, comparing, for the extracted candidates, the pixels in an area around the target pixel and the pixels in the area around the reference pixel, evaluating the candidate vectors of the evaluation value information by using the result of comparison in the entire area, and extracting motion vectors having a high evaluation value as candidates; and a motion vector determination unit determining a motion vector among the extracted motion vectors.

### BACKGROUND OF THE INVENTION

1. Field of the Invention

The present invention relates to a motion vector detection device and a motion vector detection method suitable to be applied to the detection of a motion vector from moving image data to perform image processing such as high-efficiency coding, and to a program for executing motion vector detection processing thereof.

2. Description of the Related Art

In the past, in the field of moving image processing, effective image processing has been performed with the use of motion information, i.e., the motion direction and magnitude of an object in temporally different images. For example, the result of motion detection has been used in motion-compensated inter-frame coding performed in the high-efficiency image coding and motion-based parameter control performed in a television noise reduction device using an inter-frame time domain filter. As a method of detecting a motion, a block matching method is in common use. In the block matching method, the image in one frame is divided into block units each including a predetermined number of pixels to search for an area of block motion. The motion vector detection processing according to the block matching is the most widespread common processing as the image processing using the motion vector, which is in practical use in the MPEG (Moving Picture Experts Group) format and so forth.

In the block matching method, however, the processing is performed in block units, and thus a motion in the image of each frame is not necessarily detected with high accuracy. Therefore, the present applicant has previously proposed the motion vector detection processing described in Japanese Unexamined Patent Application Publication No. 2005-175869. According to the motion vector detection processing, evaluation values relating to the motions at respective pixel positions are detected from an image signal, and the detected evaluation values are stored as an evaluation value table. From the data of the evaluation value table, a plurality of vectors are extracted as candidate vectors in one screen. Then, for each of the pixels in the entire screen, the correlation of pixels between frames associated with each other by the plurality of extracted candidate vectors is determined. As a result, the candidate vector connecting the pixels determined to have the highest correlation is determined as the motion vector corresponding to the pixels. The details of the processing will be described in embodiments described later.

FIG. 24 is a diagram illustrating the configuration of the previously proposed evaluation value table creation unit used in the determination of a motion vector by the use of the evaluation value table. In the configuration of FIG. 24, an image signal obtained at an input terminal 1 is supplied to a correlation arithmetic operation unit 2. The correlation arithmetic operation unit 2 includes a reference point memory 2a, a target point memory 2b, and an absolute value calculation unit 2c. The image signal obtained at the input terminal 1 is first stored in the reference point memory 2a. Further, the data stored in the reference point memory 2a is transferred to the target point memory 2b to store therein an image signal having a difference of one frame between the reference point memory 2a and the target point memory 2b. Then, the pixel value at a target point in the image signal stored in the target point memory 2b and the pixel value at a pixel position selected as a reference point in the image signal stored in the reference point memory 2a are read. Then, the difference between the two signals is detected by the absolute value detection unit 2c. The data of the absolute value of the detected difference is supplied to a correlation determination unit 3. The correlation determination unit 3 includes a comparison unit 3a to compare the difference with a set threshold value. From the comparison with the threshold value, an evaluation value is obtained. As the evaluation value, a correlation value can be used, for example. If the difference is equal to or less than the threshold value, for example, the correlation is determined to be high.

The evaluation value obtained at the correlation determination unit 3 is supplied to an evaluation value table calculation unit 4 to be integrated at an evaluation value integration unit 4a. The result of the integration is stored in an evaluation value table memory 4b. Then, the data stored in the evaluation value table memory 4b is supplied from an output terminal 5 to a circuit at a subsequent stage as evaluation value table data.

FIGS. 25A and 25B are diagrams illustrating an overview of a state of the related art processing of determining a motion vector by using the evaluation value table illustrated in FIG. 24. As illustrated in FIG. 25A, in a previous frame F0, which is image data one frame previous to a frame at the present time (present frame) F1, a pixel position serving as a base for determining a motion vector is first determined to be a target point d0. After the target point d0 has been determined, a search area SA in a predetermined range surrounding the pixel position of the target point d0 is set in the present frame F1. After the search area SA has been set, the evaluation value is calculated for each of the pixels in the search area SA as a reference point d1, and is registered in the evaluation value table. Then, the reference point having the highest evaluation value in the search area SA among the values registered in the evaluation value table is determined to be the pixel position in the present frame of the motion from the target point in the previous frame. As the reference point having the highest evaluation value is thus obtained, a motion vector is determined from the motion amount between the target point and the reference point having the highest evaluation value, as illustrated in FIG. 25B.

With the processing illustrated in FIGS. 24 to 25B, the motion vector can be detected on the basis of the evaluation value table data.

### SUMMARY OF THE INVENTION

In the motion vector detection based on the evaluation value table data, the determination of the optimal motion vector relies on the performance of the evaluation value table. In the related art method illustrated in FIG. 24, if the correlation is determined between the target point and the pixel as the destination of a motion candidate in the search range in a future frame (present frame), specifically if the absolute value of the difference in luminance value between the target point and the pixel is equal to or less than a certain threshold value, a frequency count is added to the evaluation value table for the motion candidate.

In the processing according to the related art method, however, if the evaluation value table is created solely on the basis of the above-described correlation determination, a false motion may be added to the table, when an image includes little spatial gradient in all or some directions in a flat part or a stripe-patterned part. As a result, the reliability of the evaluation value table is reduced. The reduction in reliability of the evaluation value table further results in a reduction in accuracy of the detected motion vector.

Further, if an image includes a plurality of motions, the related art evaluation value table is added with a false motion. Therefore, the evaluation values attributed to the respective motions are buried to make it difficult to detect the respective motion vectors.

In view of the above-described issues, the present applicant has previously proposed the configuration of the evaluation value table creation processing illustrated in FIG. 26.

The configuration of FIG. 26 is different from the configuration of FIG. 24 in that the output from the correlation determination unit 3 is subjected to the selection by a pixel selection unit 6, and thereafter is written into the evaluation value table memory 4b in the evaluation value table calculation unit 4.

The pixel selection unit 6 includes a gate unit 6a for transmitting therethrough the output from the correlation determination unit 3, and supplies the output from the gate unit 6a to the evaluation value integration unit 4a of the evaluation value table calculation unit 4.

In the pixel selection unit 6, a spatial gradient pattern calculation unit 6b calculates a target point spatial gradient pattern which represents the state of change between the target pixel stored in the target point memory 2b and a pixel adjacent to the target pixel. The spatial gradient pattern calculation unit 6b further calculates a reference point spatial gradient pattern which represents the state of change between the reference pixel stored in the reference point memory 2a and a pixel adjacent to the reference pixel. The calculated target point spatial gradient pattern and reference point spatial gradient pattern are supplied to a pattern comparison unit 6c to determine the correlation between the two patterns. The comparison is performed with reference to a spatial gradient pattern memory 6d.

Further, the pixel selection unit 6 is configured to control the transmission of the output through the gate unit 6a on the basis of the result of the correlation determination obtained at the pattern comparison unit 6c.

As illustrated in FIG. 26, with the pixel selection performed in accordance with the patterns of the target pixel and the reference pixel, only the values of the reference pixels correlated in the spatial gradient with the target pixel are written in the evaluation value table representing the motion candidates of the target pixel. Accordingly, this example has an effect of improving the accuracy of the evaluation value for detecting the motion vector.

To perform highly reliable selection at the pixel selection unit 6 illustrated in FIG. 26, however, simple correlation determination of the spatial gradient patterns between the target point and the reference point is insufficient.

That is, in the configuration of FIG. 26, the motion vector candidates are narrowed down to the motion vectors of a certain number of pixels due to the pixel selection at the gate unit 6a of the pixel selection unit 6. Further, the evaluation value table stored in the evaluation value table memory 4b constitutes a collection of motion vectors considered to be reliable to a certain extent. However, the resultant evaluation value table remains to be a collection of a large number of motion vectors. For final determination of the motion vector in the frame from the data of the evaluation value table, the motion vectors in the evaluation value table should be further narrowed down by some processing. According to methods proposed in the past, however, the detection accuracy is insufficient.

Further, the number of motion vectors present between two adjacent frames varies depending on the corresponding image. Therefore, it is not considered that the optimal number of motion vectors are detected by the related art methods. That is, according to a certain method, for example, only a fixed number of the most frequent motion vectors are extracted from a plurality of motion vectors stored in the evaluation value table. The method empirically calculates the approximate number of motion vectors present between two adjacent frames to determine the final number of motion vectors. In fact, however, images with motion are divided into images with relatively active motion in which a multitude of motion vectors are present between two frames and images in a substantially static state in which only a small number of motion vectors are present between two frames. Therefore, it is not appropriate to fix the number of motion vectors.

The present invention has been made in light of the above-described issues. It is desirable in the present invention to improve the accuracy of the detection of a motion vector with the use of an evaluation value table evaluating motion vectors. It is also desirable in the present invention to enable, even in the presence of a plurality of motions in an image, appropriate detection of the plurality of motions.

The present invention is applied to the detection of a motion vector from moving image data. Processing according to an embodiment of the present invention is configured to include a process of generating evaluation value information of motion vectors evaluating the possibility that the motion vectors are motion vector candidates, a process of extracting the motion vector candidates on the basis of the evaluation value information, and a motion vector determination process of determining a motion vector among the extracted motion vector candidates.

The process of generating the evaluation value information generates, on the basis of pixel value correlation information of a target pixel in one frame and a reference pixel in a search area in another frame, the evaluation value information of motion vectors evaluating the possibility that the reference pixel is a candidate for the destination of motion from the target pixel.

The process of extracting the motion vectors on the basis of the evaluation value information performs the comparison between the pixels in a predetermined area centering on the target pixel in the one frame and the pixels in the predetermined area centering on the reference pixel in the another frame, which is performed in the entire area, the evaluation of the respective candidate vectors of the evaluation value table on the basis of the result of the comparison, and the extraction of motion vectors having a high evaluation value as candidates.

According to an embodiment of the present invention, as the process of extracting the motion vectors on the basis of the evaluation value information, the pixels in the predetermined area centering on the target pixel and the pixels in the predetermined area centering on the reference pixel are compared with each other in the entire area to examine the correlation therebetween, and the respective candidate vectors are evaluated on the basis of the result of the comparison. Accordingly, the data of pixels selected as the evaluation value information is subjected to further selection by the comparison between the state of a peripheral area of the target pixel and the state of a peripheral area of the reference pixel.

According to an embodiment of the present invention, for the evaluation values of the motion vectors in the evaluation value information, the sum of the differences in the peripheral area of the target point as the motion start point of the respective motion vectors and the sum of the differences in the peripheral area of the reference point as the motion destination are compared with each other. Thereby, the reliabilities of the candidate vectors are appropriately evaluated.

With the use of the thus obtained reliabilities of the candidate vectors, the final motion vector can be appropriately determined among the candidates. Further, even if one image includes a plurality of motions, a plurality of vectors thereof can be appropriately determined in accordance with the appropriate number of highly reliable candidate vectors.

### BRIEF DESCRIPTION OF THE DRAWINGS

FIG. 1 is a block diagram illustrating a configuration example of a device according to an embodiment of the present invention;

FIG. 2 is a flowchart illustrating an example of overall processing according to an embodiment of the present invention;

FIG. 3 is a block diagram illustrating an example of the creation of an evaluation value table according to an embodiment of the present invention (example in which pixel selection is performed with the use of spatial gradient patterns);

FIG. 4 is a block diagram illustrating a configuration example of the processing by a motion vector extraction unit according to an example of an embodiment of the present invention;

FIG. 5 is a flowchart illustrating an example of processing of determining a pixel to be selected in accordance with the example of FIG. 3;

FIGS. 6A and 6B are explanatory diagrams illustrating an example of processing of comparing spatial gradient patterns in accordance with the example of FIG. 3;

FIGS. 7A to 7D are explanatory diagrams illustrating examples of spatial gradient codes according to the example of FIG. 3;

FIG. 8 is an explanatory diagram illustrating an example of the spatial gradient pattern according to the example of FIG. 3;

FIG. 9 is a flowchart illustrating an example of candidate vector reliability determination processing according to an embodiment of the present invention (first example);

FIGS. 10A and 10B are explanatory diagrams illustrating an overview of the reliability determination processing according to the processing example of FIG. 9;

FIG. 11 is a flowchart illustrating an example of candidate vector reliability determination processing according to an embodiment of the present invention (second example: example in which the processing is performed on two layers);

FIGS. 12A and 12B are explanatory diagrams illustrating an overview of the reliability determination processing according to the processing example of FIG. 11;

FIG. 13 is an explanatory diagram illustrating an example of an upper layer and a lower layer according to an embodiment of the present invention;

FIG. 14 is an explanatory diagram illustrating an example of the processing on the lower layer according to an embodiment of the present invention;

FIG. 15 is an explanatory diagram illustrating an example of the processing on the upper layer according to an embodiment of the present invention;

FIG. 16 is an explanatory diagram illustrating an example of an evaluation value table according to an embodiment of the present invention;

FIG. 17 is an explanatory diagram showing, in order of frequency, candidate vectors extracted from the evaluation value table according to an example of an embodiment of the present invention;

FIG. 18 is an explanatory diagram showing an example of the evaluation result on the lower layer of the candidate vectors according to an example of an embodiment of the present invention;

FIG. 19 is an explanatory diagram showing an example of the evaluation result on the upper layer of the candidate vectors according to an example of an embodiment of the present invention;

FIG. 20 is an explanatory diagram showing an example of the evaluation result on the upper and lower layers of the candidate vectors according to an example of an embodiment of the present invention;

FIG. 21 is a block diagram illustrating a configuration example of motion vector determination processing according to an example of an embodiment of the present invention;

FIG. 22 is a flowchart illustrating the processing according to the example of FIG. 21;

FIG. 23 is an explanatory diagram illustrating an example of a state of motion vector determination processing according to the example of FIG. 21;

FIG. 24 is a block diagram illustrating a configuration example of evaluation value table data generation processing according to the related art;

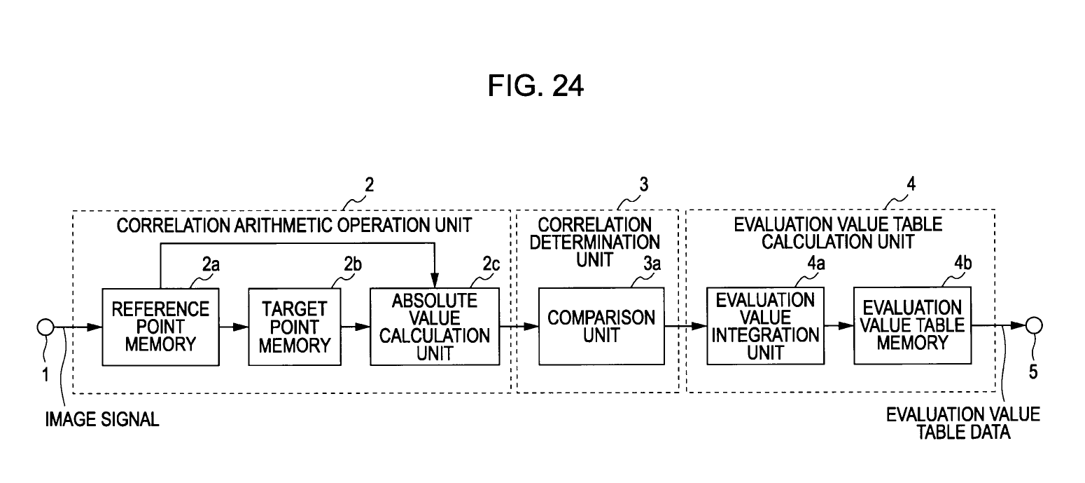

FIGS. 25A and 25B are explanatory diagrams illustrating an overview of an example of evaluation value table data generation processing according to the related art; and

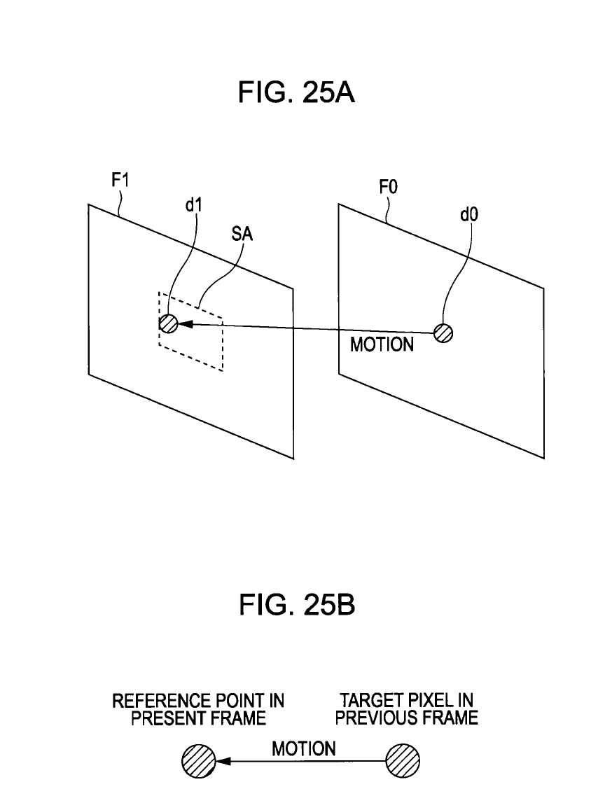

FIG. 26 is a block diagram illustrating another configuration example of evaluation value table data generation processing according to the related art.

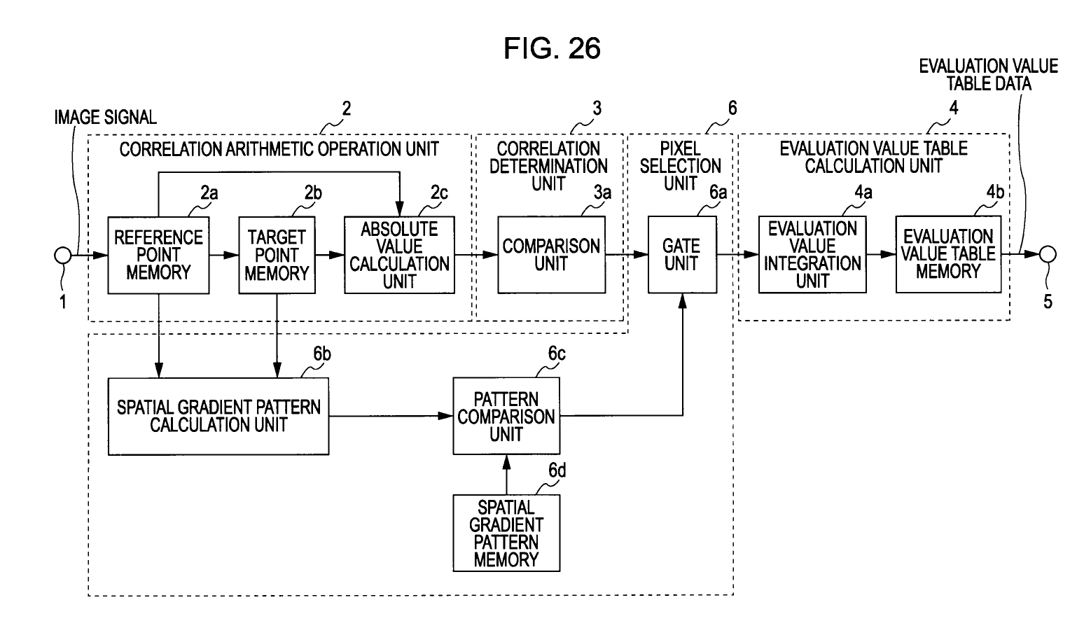

### DESCRIPTION OF THE PREFERRED EMBODIMENTS

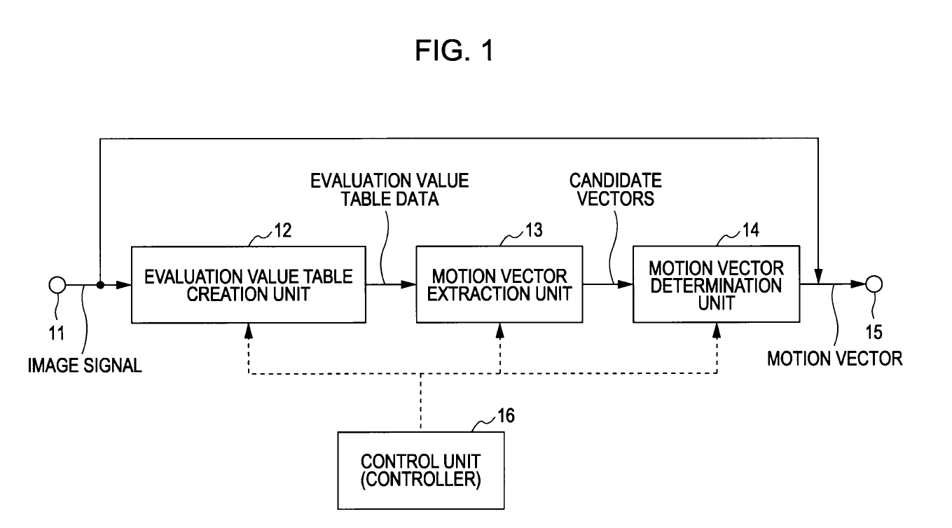

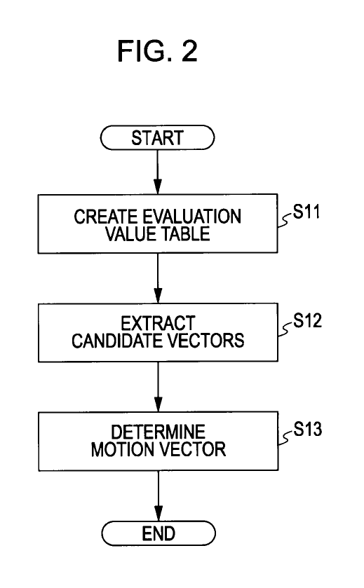

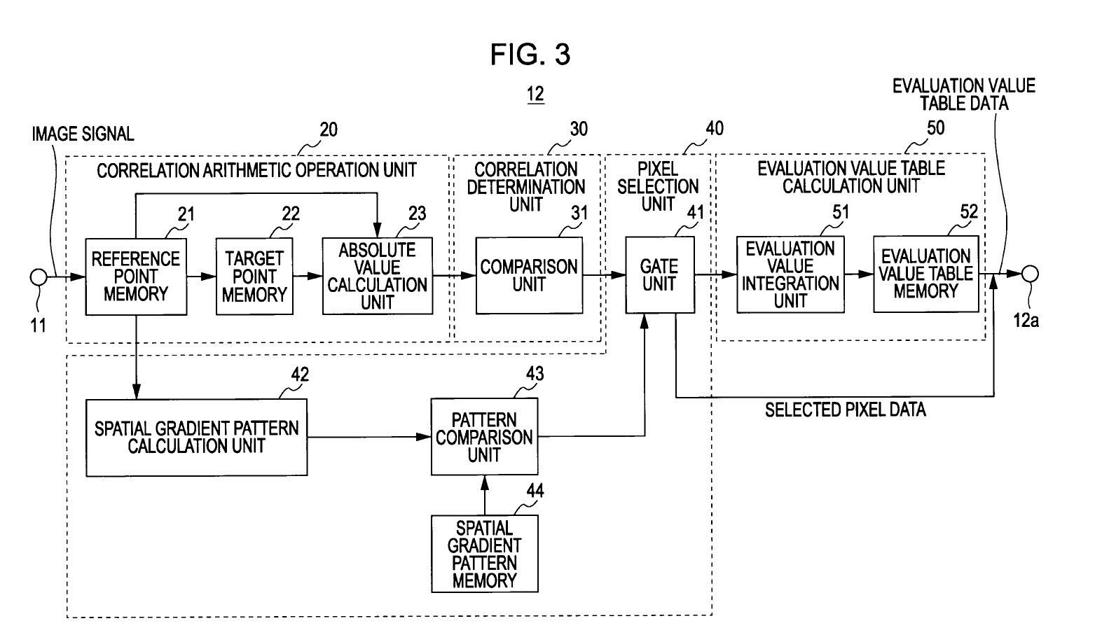

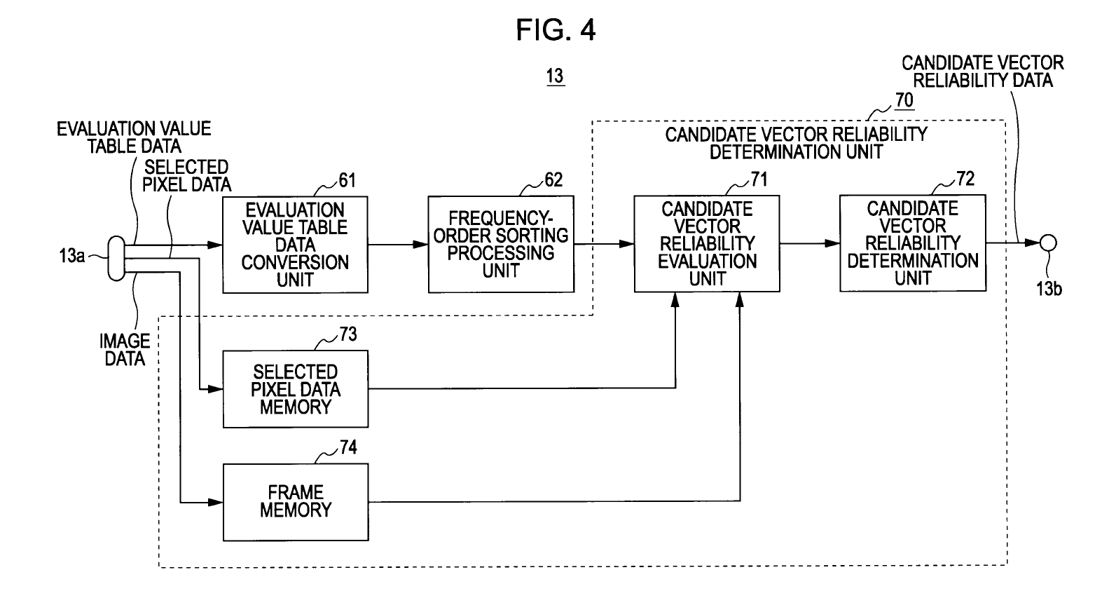

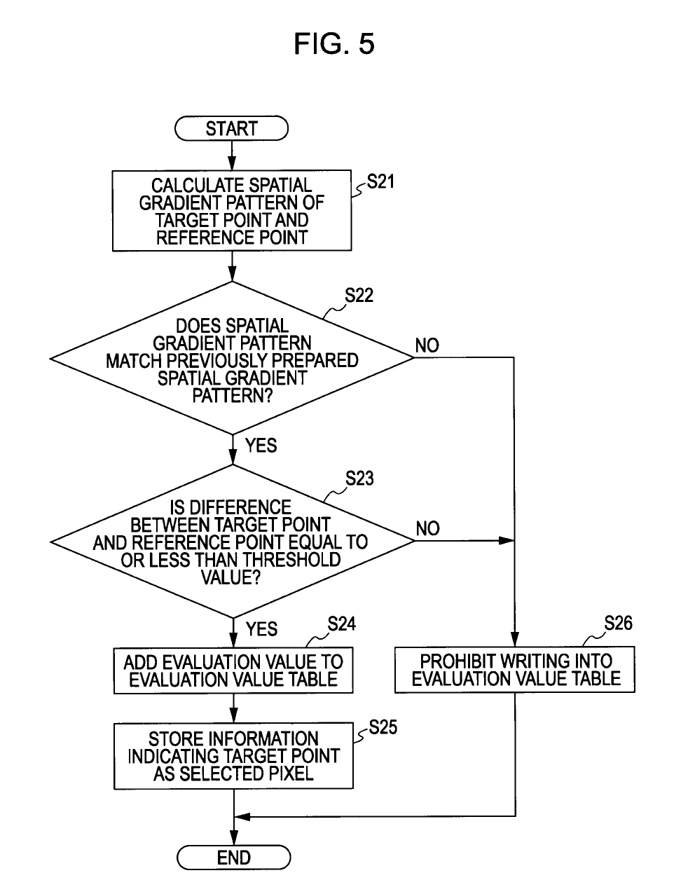

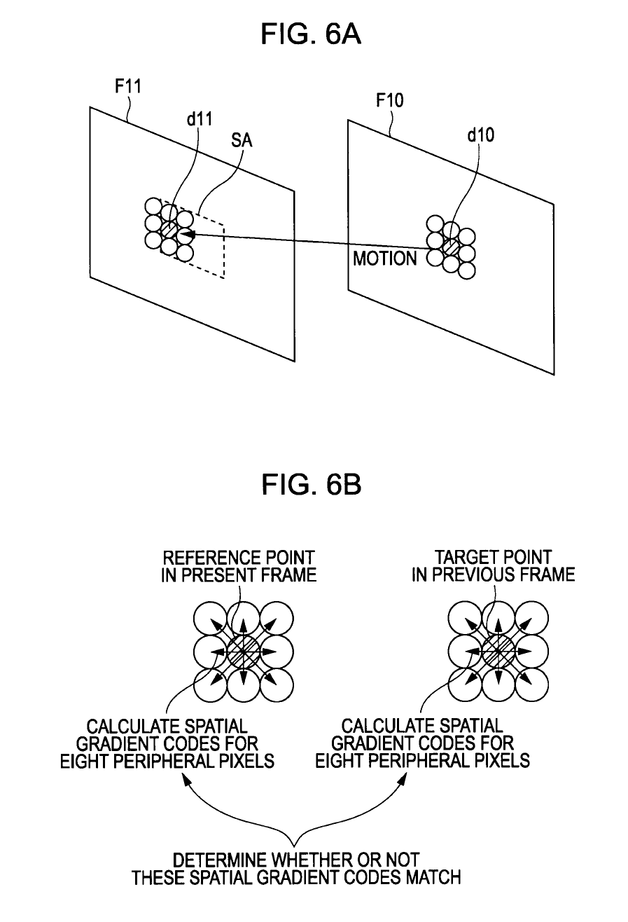

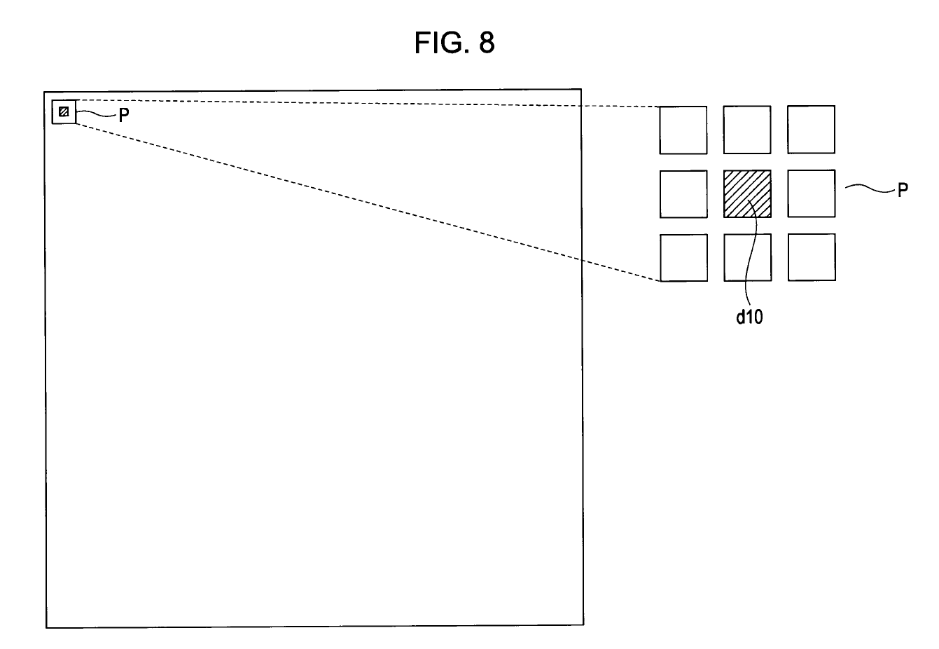

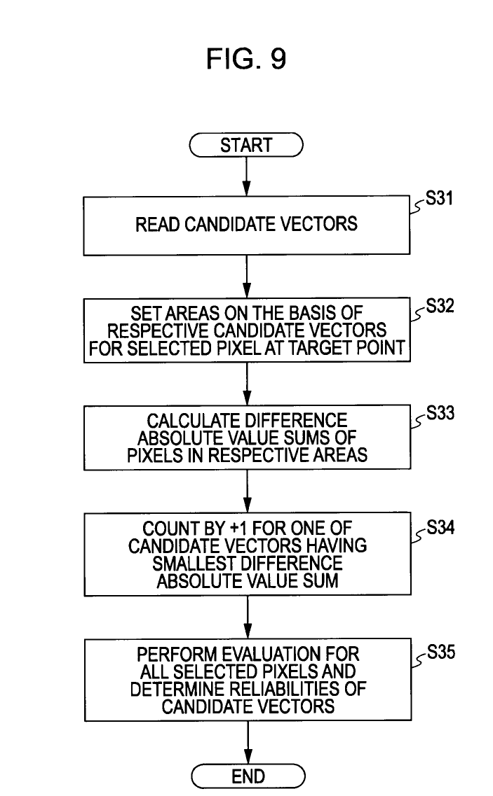

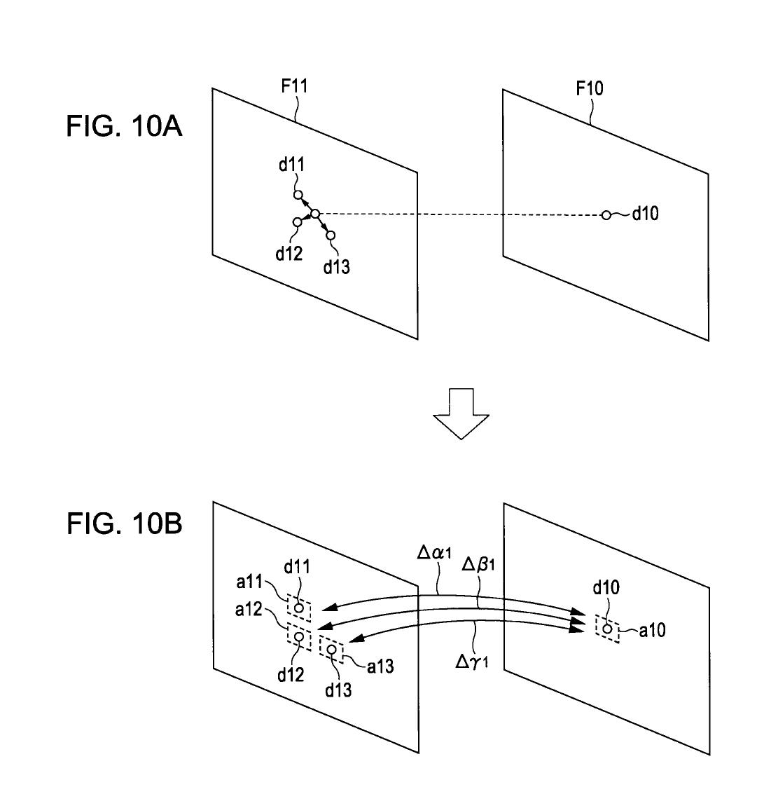

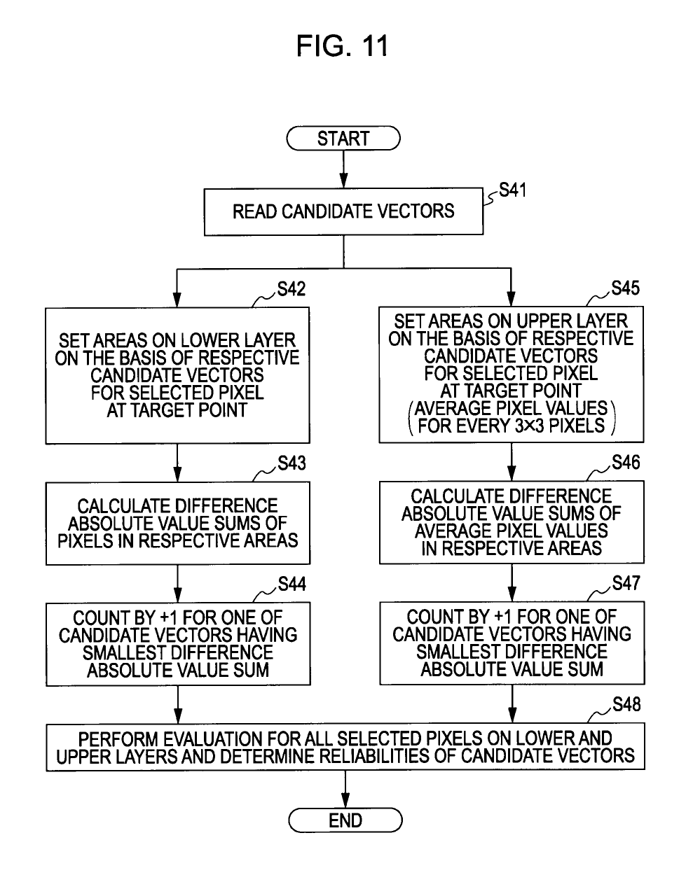

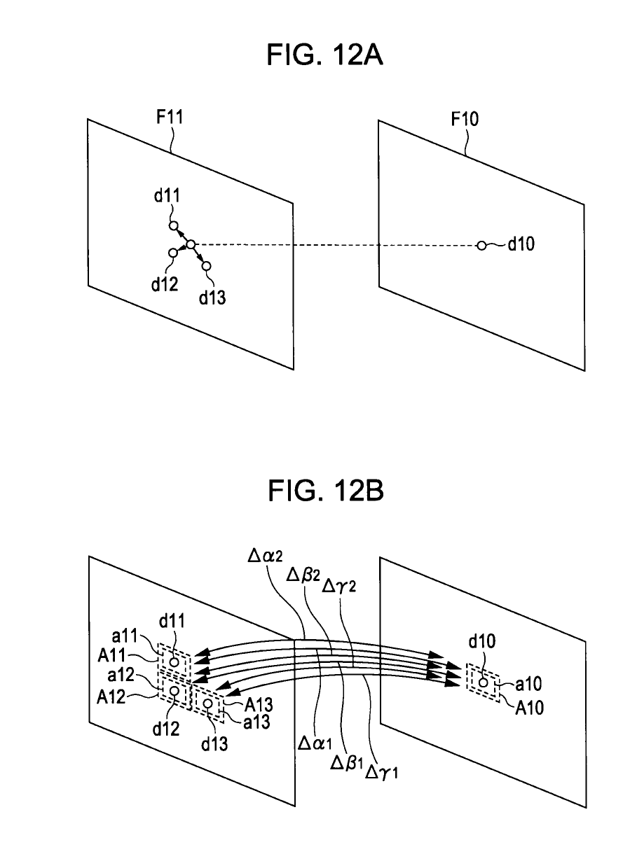

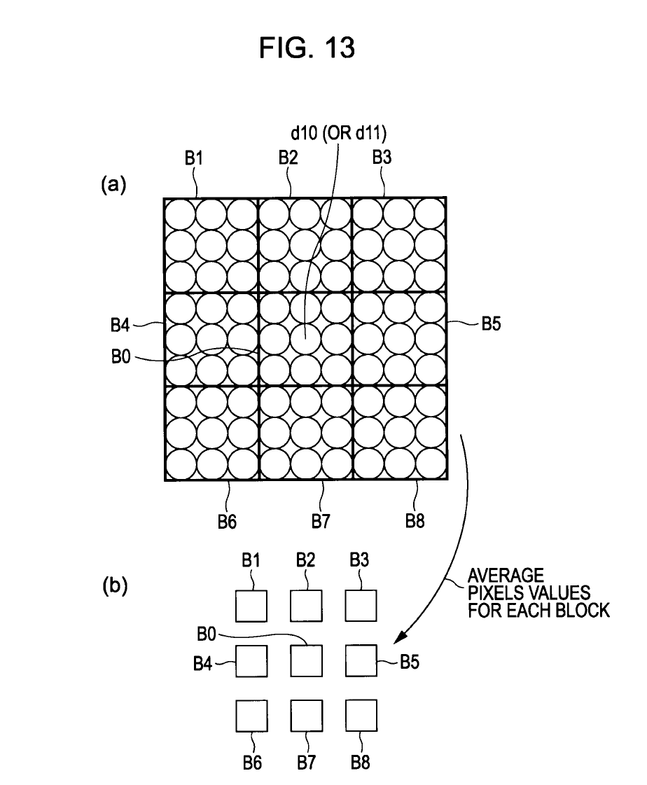

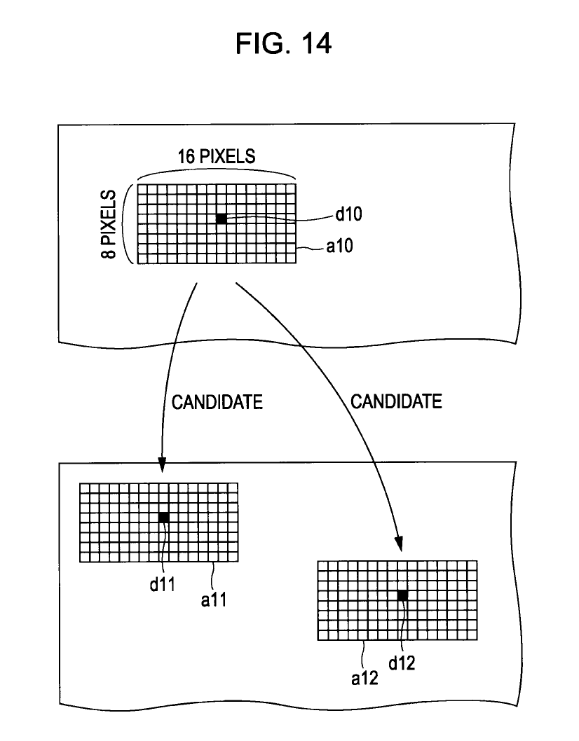

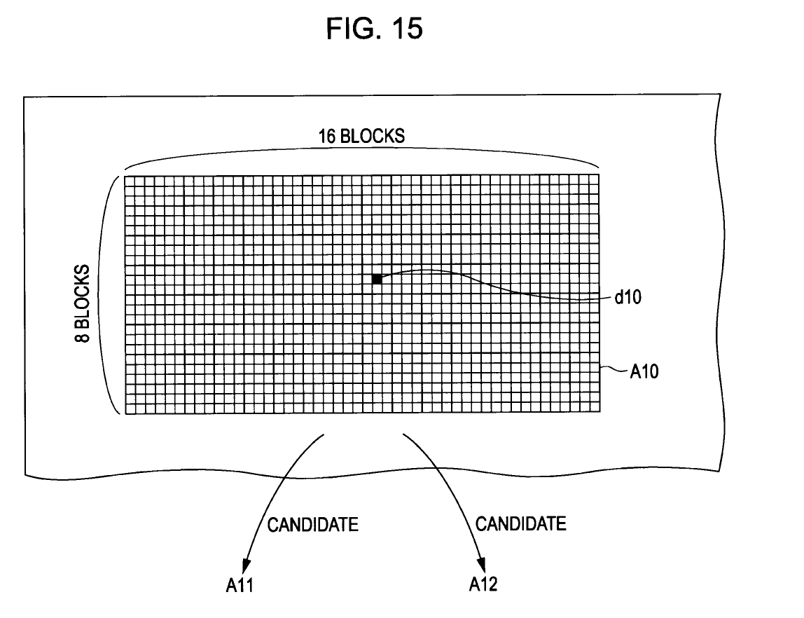

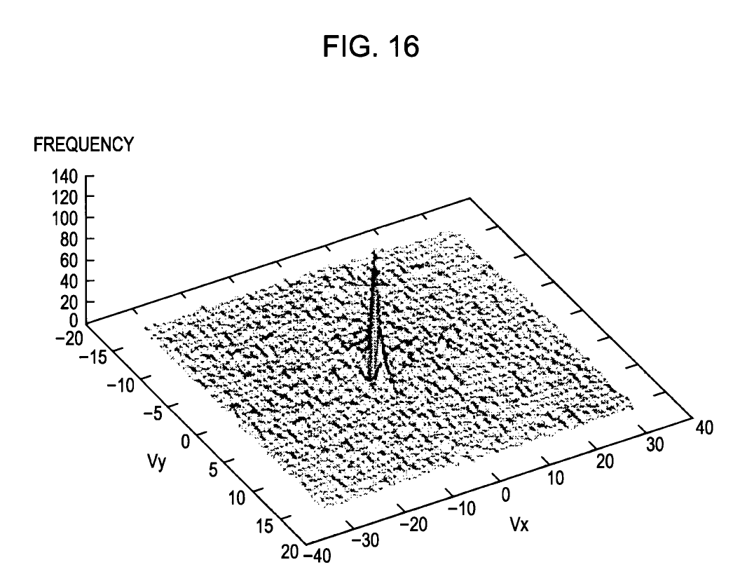

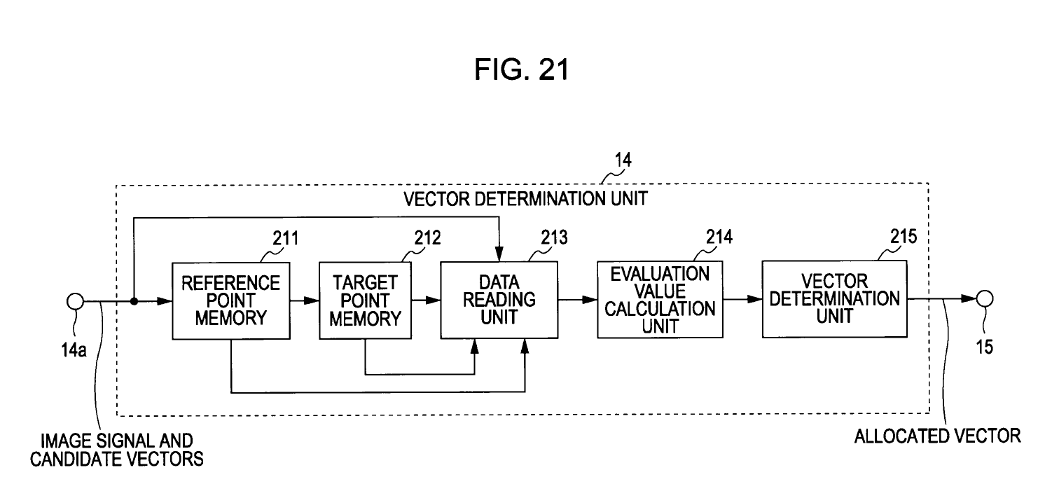

With reference to FIGS. 1 to 23, examples of embodiments of the present invention will be described in the following order: 1. Overview of Overall Configuration for Detecting Motion Vector (FIG. 1), 2. Overview of Overall Processing for Detecting Motion Vector (FIG. 2 and FIGS. 6A and 6B), 3. Configuration Example for Generating Selected Pixel Data (FIG. 3 and FIGS. 6A to 8), 4. Configuration Example of Motion Vector Extraction Unit (FIG. 4), 5. Example of Processing for Generating Selected Pixel Data (FIG. 5), 6. Example of Processing for Evaluating Reliability of Evaluation Value Table Data (Example Using only Lower Layer) (FIG. 9), 7. Description of Principle for Evaluating Reliability of Evaluation Value Table Data (FIGS. 10A and 10B), 8. Example of Processing for Evaluating Reliability of Evaluation Value Table Data (Example Using Lower and Upper Layers) (FIG. 11), 9. Description of Principle for Evaluating Reliability of Evaluation Value Table Data (Example Using Lower and Upper Layers) (FIGS. 12A to 13), 10. Description of Lower Layer and Upper Layer (FIGS. 14 and 15), 11. Example of Evaluation Value Table and Evaluation Result (FIGS. 16 to 20), 12. Example of Configuration and Operation of Motion Vector Determination Unit (FIGS. 21 to 23), and 13. Description of Modified Examples of Embodiments.

Overview of Overall Configuration for Detecting Motion Vector: The present embodiment is a motion vector detection device which detects a motion vector from moving image data. The detection processing by the motion vector detection device includes the creation of an evaluation value table on the basis of pixel value correlation information, the integration of the data of the evaluation value table, and the determination of a motion vector. In the following description, a table storing evaluation value information of motion vectors will be referred to as an evaluation value table. However, the evaluation value table may not necessarily be configured as information stored in a table format. Thus, it suffices if the evaluation value table constitutes information representing the evaluation values of motion vectors. For example, the evaluation values may be configured as histogram-formatted information, and the histogram-formatted evaluation value information may be stored.

FIG. 1 is a diagram illustrating an overall configuration of the motion vector detection device. An image signal obtained at an image signal input terminal 11 is supplied to an evaluation value table creation unit 12 to create an evaluation value table. The image signal is, for example, a digital video signal from which the individual luminance values of the respective pixels in each frame are obtained. The evaluation value table creation unit 12 creates an evaluation value table the same in size as a search area.

The evaluation value table data created by the evaluation value table creation unit 12 is supplied to a motion vector extraction unit 13. The motion vector extraction unit 13 extracts a plurality of motion vectors from the evaluation value table as candidate vectors. On the basis of a peak appearing in the evaluation value table, the motion vector extraction unit 13 extracts the plurality of candidate vectors. The details of the processing of extracting the plurality of candidate vectors will be described later. The plurality of candidate vectors extracted at the motion vector extraction unit 13 are supplied to a motion vector determination unit 14.

In accordance with region matching or the like, the motion vector determination unit 14 determines, for each of the pixels in the entire screen, the correlation between the pixels of frames associated with each other by the plurality of candidate vectors extracted at the motion vector extraction unit 13. Then, the motion vector determination unit 14 sets the candidate vector connecting the pixels or blocks having the highest correlation as the motion vector corresponding to the pixels. The above processes for obtaining the motion vector are performed under the control of a control unit (controller) 16.

The data of the set motion vector is output from a motion vector output terminal 15. In this process, the data of the motion vector may be added, as appropriate, to the image signal obtained at the input terminal 11 to be output together with the image signal. The output motion vector data is used in high-efficiency coding of image data, for example. Alternatively, the output motion vector data may be used in image quality improvement processing performed in the display of an image by a television receiver. Still alternatively, the motion vector detected by the processing of the present example may be used in other image processing.

Overview of Overall Processing for Detecting Motion Vector: The flowchart of FIG. 2 illustrates an example of the processing up to the determination of the motion vector. Firstly, an evaluation value table is created from an input image signal (Step S11), and a plurality of candidate vectors are extracted from the created evaluation value table (Step S12). Then, the motion vector having the highest correlation is determined among the plurality of extracted candidate vectors (Step S13). The processing of the flowchart of FIG. 2 is performed in each frame. The processing so far has a common configuration as the motion vector detection configuration using the evaluation value table.

In the present embodiment, the processing of evaluation value table creation by the evaluation value table creation unit 12 is performed by the configuration illustrated in FIG. 3. Herein, a target point refers to the pixel position of a point serving as a base (base point) for determining the motion vector (target pixel). A reference point refers to the pixel position of a point having a possibility of being the destination of motion from the target point (reference pixel). The reference point corresponds to a pixel in the vicinity of the pixel position of the target point (i.e., in the search area) in a frame next or previous to the frame including the target point. In the following description, the target point and the reference point will be referred to as the target pixel and the reference pixel, respectively, in some contexts. The target pixel will refer to the pixel located at the target point, and the reference pixel will refer to the pixel located at the reference point.

Prior to the description of the configuration of FIG. 3, the relationship between the target point and the reference point will be described with reference to FIG. 6A. As illustrated in FIG. 6A, in a previous frame F10, which is image data one frame previous to a frame at the present time (present frame) F11, the pixel position serving as a base for determining the motion vector is determined to be a target point d10. After the target point d10 has been determined, a search area SA in a predetermined range surrounding the pixel position of the target point d10 is set in the present frame F11. After the search area SA has been set, the evaluation value is calculated for each of the pixels in the search area SA as a reference point d11. In FIG. 6A, only one target point is illustrated for the convenience of description. In fact, however, all pixels or a plurality of representative pixels in one frame are sequentially set as the target point, and each of the pixels in the search area SA set for each of the target points is determined as the reference point.

Configuration Example for Generating Selected Pixel Data: With the target point and the reference point set as illustrated in FIG. 6A, the data of the evaluation value table is generated by the configuration of FIG. 3.

In the configuration of the example in FIG. 3, the image signal obtained at the input terminal 11 is supplied to a correlation arithmetic operation unit 20 in the evaluation value table creation unit 12. The correlation arithmetic operation unit 20 includes a reference point memory 21, a target point memory 22, and an absolute value calculation unit 23. From the image signal obtained at the input terminal 11, the pixel value in a frame used as the reference point is stored in the reference point memory 21. Then, the processing of transferring the signal of the frame stored in the reference point memory 21 to the target point memory 22 is performed in the next frame period. In this example, the reference point is included in the signal one frame previous to the present frame.

Then, the pixel value of the target point stored in the target point memory 22 and the pixel value of the reference point stored in the reference point memory 21 are supplied to the absolute value calculation unit 23 to detect the absolute value of the difference between the two signals. The difference herein refers to the difference in luminance value between the image signals. The data of the detected absolute value of the difference is supplied to a correlation determination unit 30. The correlation determination unit 30 includes a comparison unit 31 to compare the difference with a set threshold value and obtain an evaluation value. The evaluation value is, for example, a binary value indicating high correlation when the difference is equal to or less than the threshold value, and indicating low correlation when the difference exceeds the threshold value.

The evaluation value obtained at the correlation determination unit 30 is supplied to a pixel selection unit 40. The pixel selection unit 40 includes a gate unit 41 for selecting the binary values output from the correlation determination unit 30. The pixel selection unit 40 includes, as a configuration for controlling the gate unit 41, a spatial gradient pattern calculation unit 42, a pattern comparison unit 43, and a spatial gradient pattern memory 44.

The spatial gradient pattern calculation unit 42 calculates the state of spatial gradient between the target pixel and each of eight peripheral pixels adjacent to the target pixel, and calculates the state of spatial gradient between the reference pixel and each of eight peripheral pixels adjacent to the reference pixel. The state of spatial gradient of the target pixel and the state of spatial gradient of the reference pixel are determined on the basis of comparison between each of the target pixel and the reference pixel and each of the peripheral pixels adjacent to the pixel in the frame including the pixel.

FIGS. 6A and 6B are diagrams illustrating an example of the determination of the spatial gradient pattern. As described earlier, after the target point and the reference point have been set in the two adjacent frames F10 and F11,respectively, the luminance value of the pixel at the point (the pixel at the target point or the pixel at the reference point) and the luminance values of the eight peripheral pixels are determined in each of the frames.

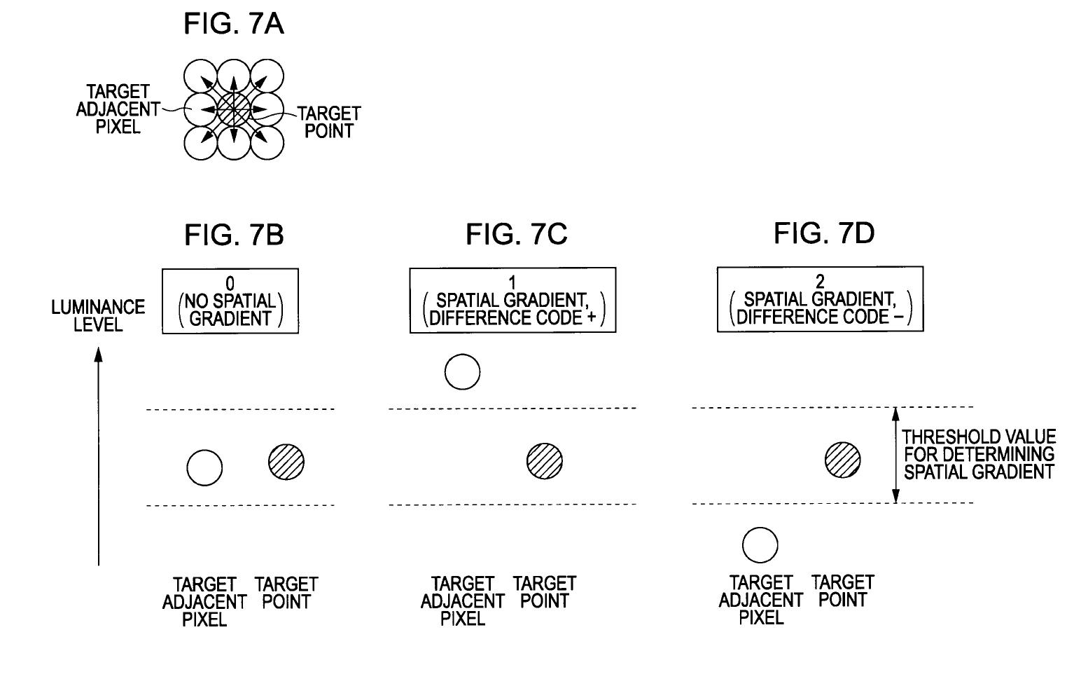

FIGS. 7A to 7D are diagrams illustrating a principle of comparing the luminance value of the target pixel or the reference pixel at the center with the luminance value of a peripheral pixel to determine a spatial gradient code.

That is, when the pixel at the target point has been determined, as illustrated in FIG. 7A, eight pixels adjacent to the target point are determined as adjacent pixels. Then, the pixel value of the target point is compared with the pixel value of each of the adjacent points to determine whether the difference in pixel value (luminance value) between the two pixels is within a predetermined range, exceeds the predetermined range in the positive direction, or exceeds the predetermined range in the negative direction, when the target point is set as a base.

FIG. 7B illustrates an example in which the difference between target point as the base and an adjacent pixel is within the predetermined range. In this case, it is determined that there is no spatial gradient between the target point and the adjacent pixel, and a spatial gradient of 0 is set. The spatial gradient of 0 indicates a state in which there is little spatial gradient between the target point and the adjacent pixel. If the predetermined range for determining the difference illustrated in FIGS. 7B to 7D is reduced, the tolerance value of the difference determined as the absence of the spatial gradient is reduced. Meanwhile, if the predetermined range is increased, the tolerance value of the difference determined as the absence of the spatial gradient is increased.

FIG. 7C illustrates an example in which the value of an adjacent pixel is greater than the value of the target point as the base, and thus the difference therebetween exceeds the predetermined range in the positive direction. In this case, it is determined that there is a spatial gradient between the target point and the adjacent pixel, and a difference code of + is set.

FIG. 7D illustrates an example in which the value of an adjacent pixel is less than the value of the target point as the base, and thus the difference therebetween exceeds the predetermined range in the negative direction. In this case, it is determined that there is a spatial gradient between the target point and the adjacent pixel, and a difference code of − is set.

In FIGS. 7A to 7D, the description has been made of the processing of determining the spatial gradient code of the target point. The description also applies to the case of the reference point. In the case of the reference point, the base set in FIGS. 7A to 7D changes to the pixel value at the reference point, and the values of the adjacent pixels correspond to the values of pixels adjacent to the reference point.

In the present embodiment, the spatial gradient pattern is determined on the basis of the spatial gradient code of the spatial gradient between the target pixel or the reference pixel at the center and each of the eight peripheral pixels thereof, which is obtained by the processing illustrated in FIGS. 7A to 7D. Specifically, if the spatial gradient codes of the spatial gradients between the target pixel or the reference pixel and the eight peripheral pixels are all the spatial gradient of 0, it is determined that the target pixel or the reference pixel has little difference in luminance from the peripheral pixels, i.e., has no spatial gradient. Further, if the target pixel or the reference pixel has a spatial gradient of + or − in any of the directions, the target pixel or the reference pixel is determined to have a spatial gradient according to the spatial gradient pattern exhibiting the spatial gradient of + or −.

FIG. 8 is a diagram illustrating an example of the spatial gradient pattern. A 9-pixel pattern P in one frame is illustrated in the left side of FIG. 8, and an enlarged view of the 9-pixel pattern P is illustrated in the right side of FIG. 8. FIG. 8 illustrates an example of a target point (target pixel) d10 and eight peripheral pixels thereof, wherein the spatial gradient codes of the spatial gradients between the target point d10 at the center and the eight peripheral pixels are all + or −.

The pattern of FIG. 8 illustrates one example. Thus, a variety of spatial gradient patterns can be set depending on the combination of the spatial gradient codes between the target point and the eight peripheral pixels.

Returning back to the description of the configuration of FIG. 3, the spatial gradient pattern calculation unit 42 of the pixel selection unit 40 calculates the spatial gradient pattern of each of the points (target pixel or reference pixel) in one frame. The result of the calculation is sent to the pattern comparison unit 43, and comparison is performed to determine whether or not the calculated spatial gradient pattern matches the spatial gradient pattern for pixel selection. To perform the comparison, the data of the pattern for pixel selection is sent to the pattern comparison unit 43 from the spatial gradient pattern memory 44.

For example, if the pixel having the spatial gradient pattern as illustrated in FIG. 8 is set as the pixel to be selected, the pattern comparison unit 43 receives the data of the pattern of FIG. 8 sent from the spatial gradient pattern memory 44, and performs the comparison to determine whether or not the received pattern matches the calculated spatial gradient pattern. Although it is most preferable to perform the comparison by using both the target point and the reference point, the comparison may also be performed with either one of the target point and the reference point.

If it is determined by the comparison at the pattern comparison unit 43 that the calculated spatial gradient pattern matches the pattern determined to have a spatial gradient, an instruction to select the corresponding pixel is transmitted to the gate unit 41. The data transmitting the instruction is selected pixel data.

Upon receipt of the instruction by the selected pixel data to select the pixel, the gate unit 41 transmits therethrough the evaluation value relating to the corresponding target point and reference point.

The evaluation value transmitted through the gate unit 41 of the pixel selection unit 40 is supplied to an evaluation value table calculation unit 50. In the evaluation value table calculation unit 50, an evaluation value integration unit 51 integrates the evaluation value and stores the result of the integration in an evaluation value table memory 52. The thus obtained data stored in the evaluation value table memory 52 is supplied, as the evaluation value table data, from an output terminal 12a to a circuit at a subsequent stage (motion vector extraction unit 13 in FIG. 1).

Further, the present embodiment is configured such that the selected pixel data supplied to the gate unit 41 is supplied from the output terminal 12a to the motion vector extraction unit 13.

Configuration Example of Motion Vector Extraction Unit: FIG. 4 is a diagram illustrating a configuration example of the motion vector extraction unit 13 of FIG. 1. In the motion vector extraction unit 13, an input terminal 13a is supplied with the evaluation value table data, the selected pixel data, and the image data.

The evaluation value table data is supplied from the evaluation value table calculation unit 50 of FIG. 3 to an evaluation value table data conversion unit 61.

The selected pixel data is supplied from the gate unit 41 of the pixel selection unit 40 of FIG. 3, and indicates the pixel position of the target point selected by the gate unit 41. The selected pixel data of the target point is supplied to a selected pixel data memory 73 to be stored therein until the completion of the processing in the corresponding frame.

The image data is of each frame under processing, and is supplied to a frame memory 74 to be stored therein until the completion of the processing in the corresponding frame.

The evaluation value table data conversion unit 61 converts the supplied evaluation value table data into such data as frequency values or differential values. The converted data is subjected to the processing by a frequency-order sorting processing unit 62 such that the candidate vectors are rearranged in one frame in order of frequency. The evaluation value table data of the candidate vectors rearranged in order of frequency is supplied to a candidate vector reliability determination unit 70.

In the candidate vector reliability determination unit 70, the evaluation value table data rearranged in order of frequency is supplied to a candidate vector reliability evaluation unit 71. The candidate vector reliability evaluation unit 71 evaluates the reliability of the candidate vectors at the positions of the respective selected pixels indicated by the selected pixel data of the target points stored in the selected pixel data memory 73. The result of the evaluation is supplied to a candidate vector reliability determination unit 72 to generate reliability data of the candidate vectors. Then, the reliability data of the candidate vectors is supplied from an output terminal 13b to a processing unit at a subsequent stage (motion vector determination unit 14 in FIG. 1).

Example of Processing for Generating Selected Pixel Data: Subsequently, description will be made of an example of processing by the configurations of FIGS. 3 and 4 of generating the selected pixel data and performing the reliability evaluation by using the generated selected pixel data.

With reference to the flowchart of FIG. 5, the processing of determining the pixel to be selected will be first described. The processing of determining the pixel to be selected is performed by the configuration of FIG. 3.

With reference to FIG. 5, the processing by the configuration illustrated in FIG. 3 corresponds to the processing of selecting the evaluation values by using the spatial gradient patterns of the target point and the reference point. In the following flowchart, description will be mainly made of the processing by the pixel selection unit 40.

The flowchart of FIG. 5 illustrates an example using the spatial gradient pattern illustrated in FIG. 8, i.e., an example of the 9-pixel pattern including one pixel at the center and eight adjacent pixels, wherein the relationships between the target point or the reference point at the center and the eight adjacent pixels are all represented by a code other than 0 (i.e., the code + or −).

Firstly, the spatial gradient pattern calculation unit 42 calculates the spatial gradient code from the spatial gradient pattern according to the difference between the target point and each of the adjacent pixels. Similarly, the spatial gradient pattern calculation unit 42 also calculates the spatial gradient code from the spatial gradient pattern according to the difference between the reference point and each of the adjacent pixels. Thereby, the spatial gradient pattern is obtained (Step S21).

Then, it is determined whether or not the obtained spatial gradient pattern matches the spatial gradient pattern previously prepared in the spatial gradient pattern memory 44 (Step S22). If the match with the prepared spatial gradient pattern is confirmed by the determination, it is determined whether or not the difference in luminance value between the pixel at the target point and the pixel at the reference point is equal to or less than a predetermined threshold value and thus the target point and the reference point are determined to be the same (Step S23).

At this step, if the target point and the reference point are determined to be the same, the corresponding evaluation value is transmitted through the gate unit 41 and integrated in the evaluation value table (Step S24). Then, the information indicating the target point as the selected pixel is stored (Step S25).

Further, if the two spatial gradient patterns do not match each other at Step S22, and if the difference between the target point and the reference point exceeds the threshold value at Step S23, the transmission of the evaluation value through the gate unit 41 is prevented to prohibit the writing of the evaluation value into the evaluation value table (Step S26).

Example of Processing for Evaluating Reliability of Evaluation Value Table Data: Subsequently, with reference to the flowchart of FIG. 9, an example of processing of evaluating the thus obtained evaluation value in the evaluation value table will be described. The processing of evaluating the evaluation value in the evaluation value table is performed by the motion vector extraction unit 13 illustrated in FIG. 4.

Firstly, the candidate vector reliability evaluation unit 71 reads the candidate vectors from the frequency-order sorting processing unit 62 (Step S31). These candidate vectors are extracted from the candidate vectors sorted in order of frequency by the frequency-order sorting processing unit 62, and are a predetermined number of the most frequent candidate vectors in one frame. In this case, for example, the first twenty candidate vectors are extracted in descending order of frequency from the candidate vectors in one frame.

Then, for the selected pixels at the target points indicated by the selected pixel data supplied from the selected pixel data memory 73, the candidate vector reliability evaluation unit 71 sets a predetermined area centering on each of the target pixels. Then, for the target pixel, the reference points are set as motion destination candidates indicated by the respective candidate vectors extracted at Step S31. For example, if the first twenty candidate vectors are extracted, as described above, twenty reference pixels are set for the selected pixel at one target point.

After the setting of the plurality of reference pixels, a predetermined area is set to center on each of the reference pixels. The size of this area is the same as the size of the area set to center on the target pixel.

Then, the pixel values of the area centering on the selected target pixel and the pixel values of the areas centering on the respective reference pixels are acquired from the frame memory 74 (Step S32).

After the acquisition of the pixel values of the respective areas, the differences between the pixel values of the respective pixels in the area centering on the target pixel and the pixel values of the respective pixels in each of the areas centering on the respective reference pixels are acquired, and the sum of the absolute values of the differences is calculated for each of the areas (Step S33). On the basis of the above calculation, among the candidate vectors extending from the selected target pixel, the candidate vector of the reference pixel having the smallest difference absolute value sum is determined to be highly reliable, and the reliability count value is incremented by +1 (Step S34).

Then, similar reliability evaluation of the candidate vectors is performed for all selected target pixels in one frame to thereafter determine the respective reliabilities of the candidate vectors (Step S35).

Description of Principle for Evaluating Reliability of Evaluation Value Table Data: Subsequently, with reference to FIGS. 10A and 10B, description will be made of the principle of reliability determination in the processing of evaluating the reliability of the evaluation value table data, which is performed by the configuration of FIG. 4 and the processing of the flowchart of FIG. 9. In the above description, twenty vectors are extracted in descending order of frequency as the candidate vectors. Herein, to simplify the description, it is assumed that three candidate vectors have been extracted in descending order of frequency.

Firstly, if the previous frame F10 includes the selected target point d10, as illustrated in FIG. 10A, three candidate vectors are allocated around the target point d10 as motion candidates. With the allocation of the candidate vectors, three reference points d11, d12, and d13 are obtained in the present frame F11 as motion destination candidates indicated by the candidate vectors.

In this case, at Step S32 of the flowchart in FIG. 9, an area a10 centering on the target point d10 is set in the previous frame F10, as illustrated in FIG. 10B. Further, areas a11, a12, and a13 centering on the reference points d11, d12, and d13, respectively, are set in the present frame F11.

The respective areas a10, a11, a12, and a13 are equal in size. For example, each of the areas includes 8 pixels in the vertical direction by 16 pixels in the horizontal direction, i.e., 128 pixels.

Then, at Step S33 of the flowchart in FIG. 9, the pixel values of the respective pixels in the area a10 surrounding the target point are compared with the pixel values of the respective pixels in each of the areas a11, a12, and a13 surrounding the respective reference points. Thereby, the differences therebetween are obtained. The differences at the respective pixel positions obtained through the comparison are converted into respective absolute values and added up in each of the areas, to thereby obtain the difference absolute value sum. Specifically, as illustrated in FIG. 10B, the differences between the respective pixels in the area a10 and the respective pixels in the area a11 are obtained, and the absolute values of the differences are added up in the areas to obtain a difference absolute value sum Δα1. Further, the differences between the respective pixels in the area a10 and the respective pixels in the area a12 are obtained, and the absolute values of the differences are added up in the areas to obtain a difference absolute value sum Δβ1. Further, the differences between the respective pixels in the area a10 and the respective pixels in the area a13 are obtained, and the absolute values of the differences are added up in the areas to obtain a difference absolute value sum Δγ1.

Then, the difference absolute value sums Δα1, Δβ1, and Δγ1 are compared with one another, and the smallest difference absolute value sum is determined to be highly reliable. In the example of FIG. 10B, it is assumed that the difference absolute value sum Δα1 is the smallest. In this case, the motion vector connecting the target point d10 and the reference point d11 is determined to be the most reliable candidate vector among the candidate vectors for the target point d10. After the determination of the most reliable candidate vector for the target point d10, the count value representing the evaluation value is incremented by +1 for the candidate vector determined to be highly reliable among the candidate vectors extracted at Step S31 of the flowchart in FIG. 9. This process corresponds to Step S34 of the flowchart in FIG. 9.

Then, the processing of calculating the reliability in the above-described manner is performed for all selected target pixels in one frame. Then, with the use of the finally obtained count values representing the evaluation values, the respective reliabilities of the plurality of candidate vectors extracted at Step S31 of the flowchart in FIG. 9 are determined.

Example of Processing for Evaluating Reliability of Evaluation Value Table Data (Example Using Lower and Upper Layers): In the example of FIGS. 9 to 10B, one area is set for each of one target point and reference points indicated by candidate vectors extending from the target point such that the area centers on the point, and the difference absolute value sum of the pixels in the area is determined. Alternatively, a plurality of areas may be set for each of the target point and the reference points. Herein, with reference to FIGS. 11 to 12B, description will be made of an example of performing the area setting on an upper layer and a lower layer, as an example of setting a plurality of areas.

Firstly, with reference to the flowchart of FIG. 11, description will be made of an example of the processing of evaluating the candidate vectors of the selected target pixel on two layers of the upper and lower layers. The processing of evaluating the candidate vectors is performed by the motion vector extraction unit 13 illustrated in FIG. 4.

With reference to FIG. 11, the candidate vector reliability evaluation unit 71 reads the candidate vectors from the frequency-order sorting processing unit 62 (Step S41). These candidate vectors are extracted from the candidate vectors sorted in order of frequency by the frequency-order sorting processing unit 62, and are predetermined number of the most frequent candidate vectors in one frame. In this case, for example, the first twenty candidate vectors are extracted in descending order of frequency from the candidate vectors in one frame. Thereafter, the processing on the lower layer and the processing on the upper layer are concurrently performed.

To perform the processing on the lower layer, the procedure proceeds to Step S42. For the selected pixels at the target points indicated by the selected pixel data supplied from the selected pixel data memory 73, the candidate vector reliability evaluation unit 71 sets a predetermined area on the lower layer centering on each of the target pixels. Then, for the target pixel, the reference points are set as motion destination candidates indicated by the respective candidate vectors extracted at Step S41. For example, if the first twenty candidate vectors are extracted, as described above, twenty reference pixels are set for the selected pixel at one target point.

After the setting of the plurality of reference pixels, a predetermined area on the lower layer is set to center on each of the reference pixels. The size of the area on the lower layer centering on each of the reference pixels is the same as the size of the area on the lower layer set to center on the target pixel.

Then, the pixel values of the area on the lower layer centering on the selected target pixel and the pixel values of the areas on the lower layer centering on the respective reference pixels are acquired from the frame memory 74 (Step S42). In this example, each of the areas on the lower layer includes, for example, 8 pixels in the vertical direction by 16 pixels in the horizontal direction, i.e., 128 pixels.

After the acquisition of the pixel values of the respective areas, the differences between the pixel values of the respective pixels in the area centering on the target pixel and the pixel values of the respective pixels in each of the areas centering on the respective reference pixels are acquired, and the sum of the absolute values of the differences is calculated for each of the areas (Step S43). On the basis of the above calculation, among the candidate vectors extending from the selected target pixel, the candidate vector of the reference pixel having the smallest difference absolute value sum is determined to be a highly reliable vector on the lower layer, and the reliability count value is incremented by +1 (Step S44).

Meanwhile, to perform the processing on the upper layer, the procedure proceeds to Step S45. For the selected pixels at the target points indicated by the selected pixel data supplied from the selected pixel data memory 73, the candidate vector reliability evaluation unit 71 sets a predetermined area on the upper layer centering on each of the target pixels. Further, also for each of the reference points located at the same positions as the reference points on the lower layer, a predetermined area on the upper layer is set to center on the reference pixel. The size of the area on the upper layer centering on the reference pixel is the same as the size of the area on the upper layer set to center on the target pixel. In this example, each of the areas on the upper layer includes, for example, 24 pixels in the vertical direction by 48 pixels in the horizontal direction, i.e., 1152 pixels. On the upper layer, however, the pixels are grouped into blocks each constituting a unit of 3 pixels in the vertical direction by 3 pixels in the horizontal direction, and the average pixel value is calculated for each of the blocks.

Then, the differences between the average pixel values of the blocks in the area centering on the target pixel and the average pixel values of the blocks in each of the areas centering on the respective reference pixels are acquired, and the sum of the absolute values of the differences is calculated for each of the areas (Step S46). On the basis of the above calculation, among the candidate vectors extending from the selected target pixel, the candidate vector of the reference pixel having the smallest difference absolute value sum is determined to be highly reliable on the upper layer, and the reliability count value is incremented by +1 (Step S47).

Then, for all selected target pixels in one frame, similar reliability evaluation of the candidate vectors on the lower layer and reliability evaluation of the candidate vectors on the upper layer are performed. Thereafter, the respective reliabilities of the candidate vectors are determined (Step S48).

Description of Principle for Evaluating Reliability of Evaluation Value Table Data (Example Using Lower and Upper Layers): Subsequently, with reference to FIGS. 12A and 12B, description will be made of the principle of reliability determination in the processing of evaluating the reliability of the evaluation value table data by using the lower and upper layers, which is performed by the processing of the flowchart of FIG. 11. To simplify the description, it is also assumed in this example that three candidate vectors have been extracted in descending order of frequency. In FIGS. 12A and 12B, the processing on the lower layer is exactly the same as the processing described in FIGS. 10A and 10B.

Firstly, if the previous frame F10 includes the selected target point d10, as illustrated in FIG. 12A, three candidate vectors are allocated around the target point d10 as motion candidates. With the allocation of the candidate vectors, three reference points d11, d12, and d13 are obtained in the present frame F11 as motion destination candidates indicated by the candidate vectors. The state of FIG. 12A is the same as the state of FIG. 10A.

Then, in the process on the lower layer performed at Step S42 of the flowchart in FIG. 11, an area a10 on the lower layer centering on the target point d10 is set in the previous frame F10, as illustrated in FIG. 12B. Further, areas a11, a12, and a13 on the lower layer centering on the reference points d11, d12, and d13, respectively, are set in the present frame F11.

The respective areas a10, a11, a12, and a13 on the lower layer are equal in size. For example, each of the areas includes 8 pixels in the vertical direction by 16 pixels in the horizontal direction, i.e., 128 pixels.

In the process on the upper layer performed at Step S45 of the flowchart in FIG. 11, an area A10 on the upper layer centering on the target point d10 is set in the previous frame F10, as illustrated in FIG. 12B. Further, areas A11, A12, and A13 on the upper layer centering on the reference points d11, d12, and d13, respectively, are set in the present frame F11.

On the upper layer, the pixels are grouped into blocks, as illustrated in FIG. 13. That is, as illustrated in (a) of FIG. 13, in the setting of the area around the target point d10 or the reference point d11, blocks B0, B1, B2, B3, B4, and so forth are set as 9-pixel units each including 3 pixels in the vertical direction by 3 pixels in the horizontal direction. The pixel values (luminance values) of nine pixels in each of the blocks are averaged. Thereby, each of the blocks has the average pixel value.

Then, as illustrated in FIG. 15, 8 blocks in the vertical direction by 16 blocks in the horizontal direction, i.e., 128 blocks are prepared. The difference absolute value sum of the average pixel values of the 128 blocks is calculated.

The respective areas A10, A11, A12, and A13 are equal in size, and are larger than the areas a10, a11, a12, and a13, respectively, on the lower layer. For example, each of the areas includes 24 pixels in the vertical direction by 48 pixels in the horizontal direction, i.e., 1152 pixels.

Returning to the description of FIG. 12B, in the process on the lower layer performed at Step S43 of the flowchart in FIG. 11, the pixel values of the respective pixels in the area a10 surrounding the target point are compared with the pixel values of the respective pixels in each of the areas a11, a12, and a13 surrounding the respective reference points. Thereby, the differences therebetween are obtained. The differences at the respective pixel positions obtained through the comparison are converted into respective absolute values and added up in each of the areas, to thereby obtain the difference absolute value sum. Specifically, as illustrated in FIG. 10B, the differences between the respective pixels in the area a10 and the respective pixels in the area a11 are obtained, and the absolute values of the differences are added up in the areas to obtain a difference absolute value sum Δα1 on the lower layer. Further, the differences between the respective pixels in the area a10 and the respective pixels in the area a12 are obtained, and the absolute values of the differences are added up in the areas to obtain a difference absolute value sum Δβ1 on the lower layer. Further, the differences between the respective pixels in the area a10 and the respective pixels in the area a13 are obtained, and the absolute values of the differences are added up in the areas to obtain a difference absolute value sum Δγ1 on the lower layer.

Similarly, at the process on the upper layer performed at Step S46 of the flowchart in FIG. 11, the pixel values of the respective pixels in the area A10 surrounding the target point are compared with the pixel values of the respective pixels in each of the areas A11, A12, and A13 surrounding the respective reference points. Thereby, the differences therebetween are obtained. The differences at the respective pixel positions obtained through the comparison are converted into respective absolute values and added up in each of the areas, to thereby obtain the difference absolute value sum. Specifically, as illustrated in FIG. 12B, the differences between the respective pixels in the area A10 and the respective pixels in the area A11 are obtained, and the absolute values of the differences are added up in the areas to obtain a difference absolute value sum Δα2 on the upper layer. Further, the differences between the respective pixels in the area A10 and the respective pixels in the area A12 are obtained, and the absolute values of the differences are added up in the areas to obtain a difference absolute value sum Δβ2 on the upper layer. Further, the differences between the respective pixels in the area A10 and the respective pixels in the area A13 are obtained, and the absolute values of the differences are added up in the areas to obtain a difference absolute value sum Δγ2 on the upper layer.

Then, the difference absolute value sums Δα1, Δβ1, and Δγ1 on the lower layer are compared with one another, and the smallest difference absolute value sum is determined to be highly reliable on the lower layer. In the example of FIG. 12B, it is assumed that the difference absolute value sum Δα1 is the smallest on the lower layer. In this case, in the determination process on the lower layer, the motion vector connecting the target point d10 and the reference point d11 is determined to be the most reliable candidate vector among the candidate vectors for the target point d10 selected in this case.

After the determination on the lower layer of the highly reliable candidate vector for the target point d10, the count value representing the evaluation value on the lower layer is incremented by +1 for the candidate vector determined to be highly reliable among the candidate vectors obtained at Step S41 of the flowchart in FIG. 11. This process corresponds to Step S44 of the flowchart in FIG. 11.

Similarly, the difference absolute value sums Δα2, Δβ2, and Δγ2 on the upper layer are compared with one another, and the smallest difference absolute value sum is determined to be highly reliable on the upper layer. In the example of FIG. 12B, it is assumed that the difference absolute value sum Δα2 is the smallest on the upper layer. In this case, in the determination process on the upper layer, the motion vector connecting the target point d10 and the reference point d11 is determined to be the most reliable candidate vector among the candidate vectors for the target point d10 selected in this case.

After the determination on the upper layer of the highly reliable candidate vector for the target point d10, the count value representing the evaluation value on the upper layer is incremented by +1 for the candidate vector determined to be highly reliable among the candidate vectors obtained at Step S41 of the flowchart in FIG. 11. This process corresponds to Step S47 of the flowchart in FIG. 11.

Then, the processing of calculating the reliability in the above-described manner is performed for all selected target pixels in one frame. Then, with the use of the finally obtained count values representing the evaluation values, the respective reliabilities of the plurality of candidate vectors extracted at Step S41 of the flowchart in FIG. 11 are determined.

In the example of FIGS. 12A and 12B, the candidate vector determined to be most reliable in the processing on the lower layer and the candidate vector determined to be most reliable in the processing on the upper layer are the same vector. However, the candidate vector determined to be most reliable is not necessarily the same between the upper and lower layers.

With the use of the evaluation values (count values) of the reliability of the candidate vectors on the lower layer and the evaluation values (count values) of the reliability of the candidate vectors on the upper layer obtained in the above-described manner, the highly reliable candidate vectors are determined among the candidate vectors in the entire screen of one frame.

In the flowchart of FIG. 11, the description has been made of the example in which the processing is performed on both the lower and upper layers. However, only the areas on the upper layer may be set to evaluate the reliability of the candidate vectors on the basis of the difference absolute value sums of the average pixel values of the blocks obtained on the upper layer.

Description of Lower Layer and Upper Layer: The example of the processing of evaluating the reliability of the candidate vectors illustrated in FIGS. 12A and 12B is separately illustrated in FIGS. 14 and 15 as the processing on the lower layer and the processing on the upper layer, respectively.

That is, on the lower layer, as illustrated in FIG. 14, the areas a10, a11, a12, and so forth each including 8 pixels by 16 pixels and centering on the selected target pixel d10 and the reference pixels d11, d12, and d13 indicated by the candidate vectors extending from the target pixel d10, respectively, are set. Then, the difference absolute value sums of the pixels in the respective areas are obtained and compared with one another.

On the upper layer, as illustrated in FIG. 15, the areas A10, A11, A12, and so forth each including 24 pixels by 48 pixels and centering on the target pixel d10 and the reference pixels d11, d12, and d13 indicated by the candidate vectors extending from the target pixel d10, respectively, are set, and the pixels are grouped into the block units each including 3 pixels by 3 pixels. Then, the difference absolute value sums of the average values of the blocks in the respective areas are obtained and compared with one another.

In the above-described manner, the count value representing the reliability is obtained for each of the motion vector candidates shown in the evaluation value table, and the candidate vectors are narrowed down on the basis of the count values representing the respective reliabilities of the candidate vectors.

Example of Evaluation Value Table and Evaluation Result: Herein, with reference to FIGS. 16 to 20, description will be made of an example of the candidate vectors obtained by the evaluation value table and the evaluation result.

Firstly, FIG. 16 illustrates an example of the evaluation value table detected for the entire screen of one frame. The example of FIG. 16 illustrates a state in which the entire screen is in motion in one direction. This example illustrates a case in which a motion represented as −3 (i.e., motion of three pixels) in the horizontal direction (Vx) and 0 (i.e., no motion) in the vertical direction (Vy) has occurred in the entire screen in one frame.

In this example, the evaluation value table data has a peak at a position of (−3, 0), which is the correct motion vector position. However, a certain number of motion vectors are also left at other vector positions as the candidates.

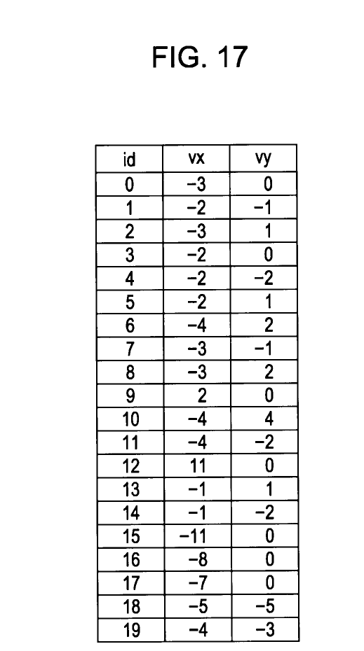

FIG. 17 shows the candidate vectors extracted in order of the frequency count value from the motion vectors in the evaluation value table in the state illustrated in FIG. 16. In the example of FIG. 17, the first twenty candidate vectors are extracted in descending order of frequency, and are assigned with numbers (ids) 0, 1, 2, . . . , and 19 in descending order of frequency.

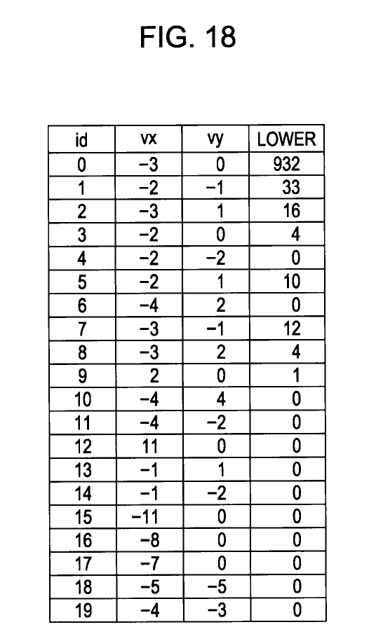

FIG. 18 shows numeric values as the result of high reliability counting of the twenty most frequent candidate vectors in FIG. 17, which is based on the determination of the difference absolute value sums in the areas on the lower layer relating to the selected target pixel. In the processing on the lower layer, the least frequent candidate vector among the candidate vectors having a count value of one or more is id9. However, in the candidate vectors id4 and id6, which are more frequent than id9, the count value is 0. The candidate vectors less frequent than id9 all have a count value of 0, i.e., the candidate vectors are determined not to be highly reliable in any of the selected pixels.

In this example, the first ten candidate vectors id0 to id9 in order of frequency located at ten coordinate positions are selected as the final candidate vectors. The data of the thus selected candidate vectors is sent to the motion vector determination unit 14 illustrated in FIG. 1 to determine the final motion vector.

In the example of FIG. 18, the determination is performed only on the lower layer. Thus, the example corresponds to the result of the processing of the flowchart in FIG. 9.

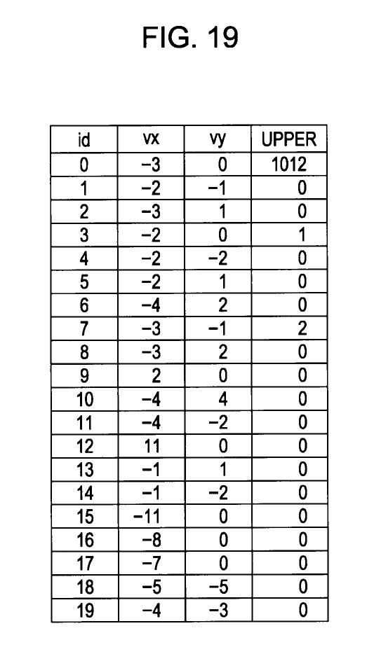

FIG. 19 shows numeric values as the result of high reliability counting of the twenty most frequent candidate vectors in FIG. 17, which is based on the determination of the difference absolute value sums in the areas on the upper layer relating to the selected target pixel. In the processing on the upper layer, the candidate vectors id0, id3, and id7 at three coordinate positions have a count value. In all of the other candidate vectors, the count value is 0, i.e., the other candidate vectors are determined not to be highly reliable in any of the selected pixels.

In this example, therefore, the candidate vectors id0, id3, and id7 at three coordinate positions are selected as the final candidate vectors. The data of the thus selected candidate vectors is sent to the motion vector determination unit 14 illustrated in FIG. 1 to determine the final motion vector.

In the example of FIG. 19, the determination is performed only on the upper layer. Thus, the example corresponds to the result of some of the processes of the flowchart in FIG. 11 (processes at Steps S41, S45, S46, S47, and S48).

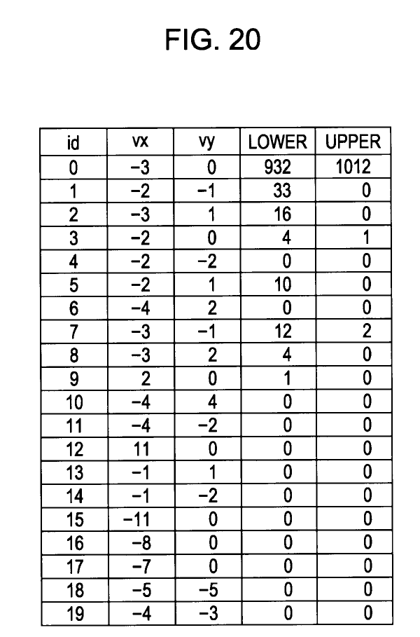

FIG. 20 shows numeric values as the result of high reliability counting based on the determination on the lower layer and numeric values as the result of high reliability counting based on the determination on the upper layer, i.e., the combination of FIGS. 18 and 19. The example of FIG. 20 corresponds to the result of the processing of the flowchart in FIG. 11.

The respective count values of the candidate vectors shown in FIG. 20 are evaluated, and a predetermined number of the most frequent candidate vectors having a count value are extracted as the candidate vectors and sent to the motion vector determination unit 14.

Which one of the determination solely on the lower layer, the determination solely on the upper layer, and the determination on two layers of the lower and upper layers is preferable to select varies depending on the state of an actual image. That is, in the case of an image with a relatively small motion, it is possible to narrow down the candidates by suitably evaluating the reliability of the candidate vectors solely with the use of the lower layer. Further, in the case of an image with a relatively large motion, it is possible to narrow down the candidates by suitably evaluating the reliability of the candidate vectors solely with the use of the upper layer.

Further, with the combined use of the lower layer and the upper layer, it is possible to handle both a relatively small motion and a relatively large motion. In the combined use of the lower layer and the upper layer, however, some process should be performed to determine the final range of the candidates on the basis of two types of count values obtained at the two layers.

With the processing of the present embodiment configured as described above, the reliability evaluation can be performed on the data of the evaluation value table narrowed down by the selected pixel data, and the process of determining the final motion vector can be suitably performed. Specifically, the final number of motion vectors in the image of one frame is determined to reflect, to a certain extent, the number of vectors determined to be highly reliable on the basis of the evaluated count values. Accordingly, the motion vector detection can be suitably performed when one image includes a plurality of motions. As compared with the related art example in which the number of motion vectors in one frame is restrictively determined as the empirically derived constant value, the present embodiment is capable of adaptively setting the number of motion vectors in accordance with the state of an actual image, and particularly capable of performing motion vector detection suitable for an image with many changes in motion.

Example of Configuration and Operation of Motion Vector Determination Unit: Subsequently, with reference to FIGS. 21 to 23, description will be made of an example of the configuration and operation of the motion vector determination unit 14 in the motion vector detection device illustrated in the configuration of FIG. 1.

FIG. 21 illustrates a configuration example of the motion vector determination unit 14 of FIG. 1. The motion vector determination unit 14 performs the processing of allocating to each of the pixels in one frame one of the plurality of candidate vectors supplied from the motion vector extraction unit 13 at the previous stage.

In this example, when each of the pixel positions is set as the target point, a fixed block as an area formed by a predetermined number of pixels is set around the target point to determine the motion vector.

With reference to FIG. 21, the configuration will be described. An input terminal 14a of the motion vector determination unit 14 is supplied with the data of the candidate motion vectors and the image signal corresponding to the candidate vectors. The image signal is supplied to a reference point memory 211 serving as a frame memory, and one frame of the image signal is stored therein. Then, the image signal stored in the reference point memory 211 is transferred to a target point memory 212 in each frame period. Therefore, the image signal stored in the reference point memory 211 and the image signal stored in the target point memory 212 are normally shifted from each other by one frame period.

Then, from the image signal stored in the target point memory 212, a data reading unit 213 reads the pixel signal of a fixed block of a predetermined size centering on the target point. Similarly, from the image signal stored in the reference point memory 211, the data reading unit 213 reads the pixel signal of a fixed block of a predetermined size centering on each of the reference points. The pixel positions of the target point and the reference points (the target pixel and the reference pixels) read by the data reading unit 213 are determined by the data reading unit 213 on the basis of the data of the candidate vectors supplied from the motion vector extraction unit 13 (FIG. 1). That is, if there are ten candidate vectors, for example, ten reference points are determined as the destinations of the ten candidate vectors extending from the target point.

Then, the pixel signal of the fixed area centering on the target point and the pixel signal of the fixed area centering on each of the reference points, which have been read by the data reading unit 213, are supplied to an evaluation value calculation unit 214 to detect the difference between the pixel signals of the two fixed areas. In this manner, the evaluation value calculation unit 214 determines the pixel signals of the fixed areas of all reference points connected to the currently evaluated target point by the candidate vectors, and compares the pixel signals with the pixel signal of the fixed area centering on the target point.

Then, on the basis of the result of the comparison, the evaluation value calculation unit 214 selects the reference point having a fixed area closest to the pixel signal of the fixed area centering on the target point.

The data of the candidate vector connecting the selected reference point and the target point is sent to a vector determination unit 215. The vector determination unit 215 performs determination processing of allocating the candidate vector as the motion vector extending from the target point, and outputs the determined candidate vector from the output terminal 15.

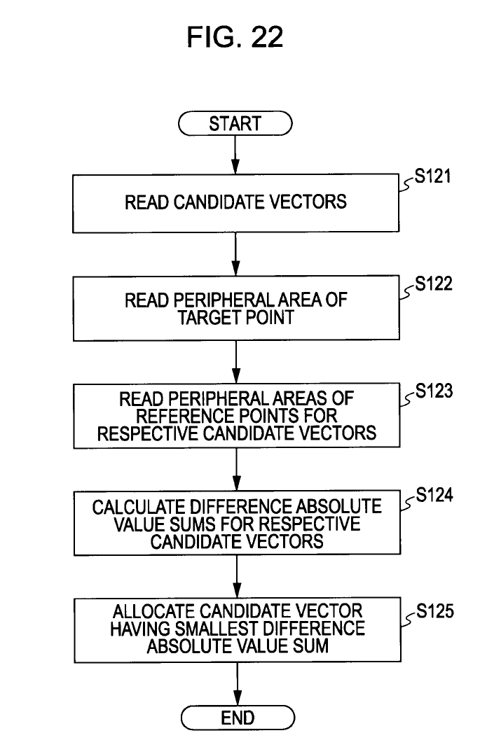

The flowchart of FIG. 22 illustrates an example of the vector determination (allocation) operation of FIG. 21. Description will be made in order with reference to FIG. 22. The candidate vectors are first read on the basis of the data of the evaluation value table (Step S121). The coordinate position of the target point corresponding to the read candidate vectors is determined, and the pixels of a fixed block formed by the pixel at the position (target pixel) and the peripheral pixels thereof are read from the target point memory 212 (Step S122). Further, the coordinate position of each of the reference points corresponding to the read candidate vectors is determined, and the pixels of a fixed block formed by the pixel at the position (reference pixel) and the peripheral pixels thereof are read from the reference point memory 211 (Step S123).

Then, the absolute value sum of the differences in pixel level (pixel value: luminance value in this case) in each of the fixed blocks is calculated (Step S124). The processing so far is performed for the reference points indicated by all candidate vectors corresponding to the present target point.

Then, the difference absolute value sums calculated for the respective fixed blocks set for the reference points are compared with the difference absolute value sum of the fixed block set for the target point, and the reference point having the smallest difference is sought. After the reference point having the smallest difference has been determined in the above process, the candidate vector connecting the determined reference point and the target point is determined to be allocated as the motion vector for the target point (Step S125).

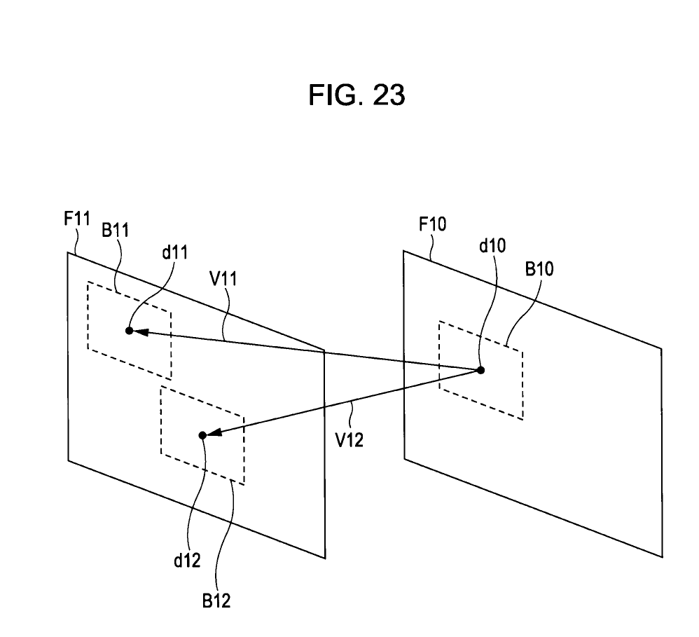

FIG. 23 is a diagram illustrating an overview of the configuration of FIG. 21 and the processing of the flowchart of FIG. 22.

In this example, it is assumed that the frame F10 (target frame) includes the target point d10, and that a plurality of candidate vectors V11 and V12 are present between the frame F10 and the frame F11 (reference frame) next thereto on the time axis. The frame F11 includes the reference points d11 and d12 connected to the target point d10 by the candidate vectors V11 and V12, respectively.

With the state of FIG. 23 assumed as above, at Step S122 of FIG. 22, a fixed block B10 including a predetermined number of pixels is fixedly set to center on the target point d10 in the frame F10, and the absolute value sum of the differences in pixel value in the fixed block B10 is calculated. Similarly, at Step S123 of FIG. 22, fixed blocks B11 and B12 each including a predetermined number of pixels are fixedly set to center on the reference points d11 and d12, respectively, in the frame F11, and the respective absolute value sums of the differences in pixel value in the fixed blocks B11 and B12 are separately calculated.

Then, comparison is performed to determine which one of the absolute value sum of the differences in the fixed block B11 and the absolute value sum of the differences in the fixed block B12 is closer to the absolute value sum of the differences in the fixed block B10. If it is determined by the comparison that the absolute value sum of the differences in the fixed block B11 is closer to the absolute value sum of the differences in the fixed block B10, for example, the candidate vector V11 connecting the reference point d11 at the center of the fixed block B11 and the target point d10 is selected. The selected candidate vector V11 is allocated as the motion vector for the target point d10.

To simplify the description, the description in FIG. 23 has been made on the assumption that there are two candidate vectors. In fact, however, there are cases in which a larger number of candidate vectors exist for one target point. Further, only one target point is illustrated to simplify the description. In fact, however, all pixels or a plurality of representative pixels in one frame are set as the target point as described above.

With the processing of thus determining the vector to be selected from the candidate vectors, the vector connecting the target point and the reference point close to each other in the state of the peripheral pixels thereof is selected. Accordingly, the motion vector allocated to each of the pixels can be suitably selected.

Description of Modified Examples of Embodiments: In the embodiments described above, specific description has not been given to the processing of selecting the target point. The embodiments may be configured, for example, such that all pixels in one frame are sequentially selected as the target point, and that the motion vector is detected for each of the pixels. Alternatively, the embodiments may be applied to select a representative pixel in one frame as the target point and detect the motion vector for the selected pixel.

Further, in the processing of selecting the reference points for the target point, the search area SA illustrated in FIG. 6A and so forth is one example. Thus, the selection of a variety of search areas can also be applied.

Further, in the above-described embodiments, in the processing of selecting the final candidate vectors from the evaluation result of the candidate vectors shown in FIGS. 18 to 20, the range not including a candidate vector determined to be reliable, i.e., the range including a succession of count values of 0 in FIG. 18 and so forth is excluded to select the higher range. Alternatively, a candidate vector having a count value other than 0 may also be eliminated. For example, in the example of FIG. 18, in which the first ten candidate vectors are selected, a candidate vector having a small count value, such as a single-digit value, may be excluded.

Further, the pixel size of each of the areas on the respective layers illustrated in the above-described embodiments is one example. Thus, the areas may have other sizes.

Further, the signal in each of the areas is used to calculate the sum of the absolute values of the differences of the respective pixel values in the area. Alternatively, the correlation between the areas may be determined by other arithmetic operation processing. For example, the differences of the pixel values in the areas may not be converted into the absolute values, but may be directly added up to determine the direction of the change in the pixel values. Further, the correlation value of two areas may be obtained by arithmetic operation processing not using the difference absolute value sum, and the determination may be made on the basis of the magnitude of the correlation value.

Further, in the above-described embodiments, the description has been made of the example in which the luminance signal is applied as the pixel value of the image signal. Alternatively, another signal component obtained in pixel units, such as the color signal and the color difference signal, may be used.

Further, in the respective embodiments described above, the description has been made of the example configured as a motion vector detection device for detecting a motion vector from an image signal. Alternatively, the motion vector detection device may be incorporated into a variety of image processing devices. For example, the motion vector detection device can be incorporated into a coding device which performs high-efficiency coding, to thereby perform coding using motion vector data. Alternatively, the motion vector detection device may be incorporated into an image display device which displays an image by using input (received) image data or an image recording device which records an image, to thereby use motion vector data for improving the image quality.

Further, the respective constituent elements for performing the motion vector detection according to an embodiment of the present invention may be implemented as a program. Then, the program may be installed in a variety of information processing devices, such as a computer device which performs a variety of data processing, for example, to perform processing similar to the foregoing processing in the processing of detecting a motion vector from an image signal input to the information processing devices.

The present application contains subject matter related to that disclosed in Japanese Priority Patent Application JP 2008-196612 filed in the Japan Patent Office on Jul. 30, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A motion vector detection device comprising:
an evaluation value information creation unit configured to create, on the basis of pixel value correlation information of a target pixel in one frame on the time axis and a reference pixel in a search area in another frame on the time axis in moving image data formed by a plurality of frames, evaluation value information of motion vectors evaluating the possibility that the reference pixel is a candidate for the destination of motion from the target pixel;
a motion vector extraction unit configured to extract motion vector candidates of each of the pixels in a frame of the moving image data on the basis of the evaluation value information created by the evaluation value information creation unit, compare, for each of the extracted candidates, the pixels in a predetermined area centering on the target pixel in the one frame with the pixels in the predetermined area centering on the reference pixel in the another frame to examine the correlation therebetween, evaluate the respective candidate vectors of the evaluation value information on the basis of the result of the comparison performed in the entire predetermined area to examine the correlation, and extract motion vectors having a high evaluation value as candidates; and
a motion vector determination unit configured to determine a motion vector among the motion vectors extracted as the candidates by the motion vector extraction unit.

2. The motion vector detection device according to claim 1,
wherein the evaluation value information creation unit creates the evaluation value information on the basis of the result of pixel selection performed on the basis of the spatial gradient state between the target point and each of peripheral pixels thereof and the spatial gradient state between the reference point and each of peripheral pixels thereof, and
wherein the motion vector extraction unit performs, for each of motion vectors of pixels selected by the pixel selection, the comparison between the pixels in the predetermined area centering on the target pixel in the one frame and the pixels in the predetermined area centering on the reference pixel in the another frame, which is performed in the entire area to examine the correlation therebetween.

3. The motion vector detection device according to claim 2,
wherein, in the comparison performed by the motion vector extraction unit to examine the correlation between the pixels in the predetermined area, the differences between the pixels in the predetermined area centering on the target pixel and the pixels in the predetermined area centering on the reference pixel are calculated, and the absolute values of the differences are added up in the predetermined area to obtain a difference absolute value sum, and
wherein a motion vector corresponding to the smallest difference absolute value sum is determined to be a candidate.

4. The motion vector detection device according to claim 3,
wherein an area including a first number of pixels and centering on the target pixel or the reference pixel and an area including a second number, which is different from the first number, of pixels and centering on the target pixel or the reference pixel are set as the predetermined area, and
wherein the motion vector candidates are determined on the basis of the difference absolute value sums in the two areas.

5. The motion vector detection device according to claim 4,
wherein the area including the second number of pixels is formed by a collection of blocks each including a predetermined number of pixels, and
wherein pixel values are averaged in the block units to compare the difference absolute value sums of the block units.

6. The motion vector detection device according to claim 3,
wherein the predetermined area is formed by a collection of blocks each including a predetermined number of pixels, and
wherein pixel values are averaged in the block units to compare the difference absolute value sums of the block units.

7. The motion vector detection device according to claim 2,
wherein the motion vector extraction unit sorts the determined candidate motion vectors on the basis of the motion direction and the motion amount thereof, counts the number of the sorted motion vector candidates, and narrows down the candidates to a sequence of a predetermined number of motion vectors selected in descending order of count number.

8. The motion vector detection device according to claim 2,
wherein the motion vector determination unit allocates the motion vectors extracted as the candidates by the motion vector extraction unit to all pixels or representative pixels in one frame, examine the correlation between an area including the position of each of the vector-allocated pixels and the periphery thereof and a motion destination area, and determines a motion vector corresponding to the most highly correlated areas to be the motion vector of the corresponding pixel.

9. A motion vector detection method comprising the steps of:
creating, on the basis of pixel value correlation information of a target pixel in one frame on the time axis and a reference pixel in a search area in another frame on the time axis in moving image data formed by a plurality of frames, an evaluation value table evaluating the possibility that the reference pixel is a candidate for the destination of motion from the target pixel;
extracting motion vector candidates of each of the pixels in a frame of the moving image data on the basis of the created evaluation value table;
performing, as the selection of the candidates extracted at the step of extracting the motion vectors, the comparison between the sum of differences of the pixels in a predetermined area centering on the target pixel in the one frame and the sum of differences of the pixels in the predetermined area centering on the reference pixel in the another frame, the evaluation of the respective candidate vectors of the evaluation value table on the basis of the result of the comparison, and the determination of motion vectors having a high evaluation value as candidates; and
determining a motion vector among the motion vectors having the high evaluation value.

10. A program installed in an information processing device to cause the information processing device to execute:
a process of creating, on the basis of pixel value correlation information of a target pixel in one frame on the time axis and a reference pixel in a search area in another frame on the time axis in moving image data formed by a plurality of frames, an evaluation value table evaluating the possibility that the reference pixel is a candidate for the destination of motion from the target pixel;
a process of extracting motion vector candidates of each of the pixels in a frame of the moving image data on the basis of the created evaluation value table;
a motion vector evaluation process of performing, as the selection of the candidates extracted at the step of extracting the motion vectors, the comparison between the sum of differences of the pixels in a predetermined area centering on the target pixel in the one frame and the sum of differences of the pixels in the predetermined area centering on the reference pixel in the another frame, the evaluation of the respective candidate vectors of the evaluation value table on the basis of the result of the comparison, and the determination of motion vectors having a high evaluation value as candidates; and
a motion vector determination process of determining a motion vector among the motion vectors having the high evaluation value determined as the candidates in the motion vector evaluation process.
